(19) United States
(12) Patent Application Publication
(10) Pub. No.: US 2025/0094528 A1
(43) Pub. Date: Mar. 20, 2025

(54) SYSTEMS AND METHODS FOR GAUSSIAN PROCESS MODELING FOR HETEROGENEOUS FUNCTIONS

(71) Applicants: Mohit Malu, Tempe, AZ (US); Giulia Pedrielli, Tempe, AZ (US); Gautam Dasarathy, Chandler, AZ (US); Andreas Spanias, Tempe, AZ (US)

(72) Inventors: Mohit Malu, Tempe, AZ (US); Giulia Pedrielli, Tempe, AZ (US); Gautam Dasarathy, Chandler, AZ (US); Andreas Spanias, Tempe, AZ (US)

(73) Assignee: Arizona Board of Regents on Behalf of Arizona State University, Tempe, AZ (US)

(21) Appl. No.: 18/890,651

(22) Filed: Sep. 19, 2024

Related U.S. Application Data
(60) Provisional application No. 63/539,278, filed on Sep. 19, 2023.

(51) Int. Cl. G06F 17/13

(52) U.S. Cl. CPC G06F 17/13

(57) ABSTRACT

A system implements a modeling (ClassGP) and an optimization (ClassBO) framework that models heterogeneous functions with knowledge of individual partitions within classes, i.e., heterogeneous functions including non-stationary functions which can be divided into locally stationary functions over partitions of input space with an active stationary function in each partition. The framework constructs a class likelihood for the class by combining log marginal likelihoods associated with each partition of the plurality of partitions within the class. The framework aims to improve analysis of systems that are characterized by a discrete and finite number of “classes” of behaviors.

### CROSS REFERENCE TO RELATED APPLICATIONS

This is a non-provisional application that claims benefit to U.S. Provisional Application Ser. No. 63/539,278 filed on Sep. 19, 2023, which is herein incorporated by reference in its entirety.

### GOVERNMENT SUPPORT

This invention was made with government support under 2003081, 2048223, 2200161, and 1540040 awarded by the National Science Foundation. The government has certain rights in the invention.

### FIELD

The present disclosure generally relates to modeling techniques for black-box functions, and in particular, to a system and associated method for modeling and optimization of unknown, globally non-stationary heterogeneous functions that can be applied in various science and engineering applications.

### BACKGROUND

Gaussian Processes (GP) are a powerful framework for modeling expensive black-box functions. However, many current modeling frameworks operate under assumptions of stationarity of an underlying, unknown function. When applied for modeling and optimization of real-world systems, this assumption can lead to significant limitations and inaccuracies.

It is with these observations in mind, among others, that various aspects of the present disclosure were conceived and developed.

### BRIEF DESCRIPTION OF THE DRAWINGS

The present patent or application file contains at least one drawing executed in color. Copies of this patent or patent application publication with color drawing(s) will be provided by the Office upon request and payment of the necessary fee.

FIGS. 1A and 1B are a pair of graphical representations showing a heterogeneous function (FIG. 1B) over the class-partition space (FIG. 1A) with axis-aligned partitions (Pⱼ) and classes (Cᵢ);

FIG. 1C is a diagram showing a class-partition space (of an input space) with axis-aligned partitions (Pⱼ) and classes (Cᵢ);

FIG. 2A shows a system including a computing device for implementation of a heterogeneous function modeling framework outlined herein;

FIG. 2B shows an overview of the system implementing the heterogeneous function modeling framework, the system being operable to determine a heterogeneous function model that correlates with an unknown or “black-box” non-stationary function belonging to an observed system;

FIG. 2C shows further information about the system of FIG. 2B including a method corresponding with a “ClassGP” embodiment outlined herein;

FIG. 2D shows further information about the system of FIG. 2B including how the system determines partitions for each class inherent to the observed system and how the heterogeneous function model incorporates partition-level likelihoods into an overall class likelihood function for each class;

FIG. 3A shows an example binary classification tree which can be constructed and used by the system of FIG. 2B to identify partitions within classes based on observation data, where inputs start at a “root node” of the binary classification tree and can be classified into one of a plurality of partitions that respectively correspond to “leaf nodes” of the binary classification tree;

FIG. 3B shows a simplified example of development of a heterogeneous function model based on observation data where two instances of observation data belong to different partitions but the same class;

FIG. 4A shows a method corresponding with a “ClassBO” embodiment outlined herein that incorporates and builds upon aspects of the method of FIG. 2C;

FIG. 4B shows an example binary classification tree being subjected to a refinement step associated with the method of FIG. 4A;

FIGS. 5A and 5B are a pair of graphical representations showing an effect of varying a number of partitions for noiseless 2D (FIG. 5A) and 3D (FIG. 5B) harmonic function evaluation as performed by a system implementing a framework outlined herein (“ClassGP”);

FIGS. 6A and 6B are a pair of graphical representations showing an effect of varying a number of classes for noiseless 2D (FIG. 6A) and 3D (FIG. 6B) harmonic function evaluation as performed by the system implementing the ClassGP framework outlined herein;

FIGS. 7A and 7B are a pair of graphical representations showing an effect of varying a training budget for noiseless 2D (FIG. 7A) and 3D (FIG. 7B) harmonic function evaluation as performed by the system implementing the ClassGP framework outlined herein;

FIGS. 8A and 8B are a pair of graphical representations showing an effect of varying a dimension for noiseless 2D (FIG. 8A) and 3D (FIG. 8B) harmonic function evaluation as performed by the system implementing the ClassGP framework outlined herein;

FIGS. 9A-9D are a series of graphical representations showing performance comparison of ClassBO and TURBO for unbalanced sub-regions with increasing classes for noisy data, with values of k being held constant with variations in number of partitions p other parameters—d=2, N=5, T=150, Runs=5—note how Max observed reward goes beyond objective maximum due to the presence of noise; and

FIGS. 10A-10D are a series of graphical representations showing performance comparison of ClassBO and TURBO for unbalanced sub-regions with increasing classes for noisy data, with variations in k being held constant with number of partitions p held constant, and other parameters—d=2, N=5, T=150, Runs=5—note how Max observed reward goes beyond objective maximum due to the presence of noise.

Corresponding reference characters indicate corresponding elements among the view of the drawings. The headings used in the figures do not limit the scope of the claims.

### DETAILED DESCRIPTION

### 1. Introduction

Many modern-day science and engineering applications, such as machine learning, hyperparameter optimization of neural networks, robotics, cyber-physical systems, etc., call for modeling techniques to model black-box functions. Gaussian Process (GP) modeling is a popular Bayesian non-parametric framework heavily employed to model expensive black-box functions for analysis such as prediction or optimization. Traditionally, GP models assume stationarity of the underlying, unknown, function. As a result, a unique covariance kernel (with constant hyperparameters) can be used over the entire domain. However, many real-world systems such as cyber-physical, natural, recommendation can only be characterized by locally stationary but globally non-stationary functions. Breaking the assumption underlying the stationary kernel can deteriorate the quality of predictions generated by the GP.

Bayesian optimization (BO) is a powerful sequential optimization algorithm for non-convex expensive to evaluate black-box functions due to its sample efficient and derivative free framework. The standard BO includes two key components: (i) Bayesian statistical prior (typically Gaussian Process) to model the function to be optimized; and (ii) acquisition functions to navigate the input space efficiently. Bayesian statistical prior typically assumes the homogeneity of the function over the domain, which allows the use of a single covariance kernel function with constant hyperparameters over the entire domain to model the function. However, in many emerging engineering applications such as robotics, circuit design optimization, and the falsification of Cyber-Physical systems, the function to be optimized is heterogeneous with some underlying structure. The standard BO algorithm does not utilize the underlying structure for optimization. Further, its performance for heterogeneous functions drops significantly due to very small kernel length scale values to capture high-frequency components, leading to inadequate sampling in smooth or low-frequency regions. Hence, these drawbacks call for more efficient and sophisticated optimization techniques that can effectively utilize the underlying structure to sample the input space efficiently.

In many engineering systems, a finite set of locally stationary functions can characterize the heterogeneous functions where one can evaluate the structure of the non-stationarity or is known a priori. For example, a vehicle's automatic transmission will exhibit switching behaviors with a discrete and finite number of switches (gear changes). When a specific behavior (gear) is exercised, the system exhibits smooth state dynamics, and the associated metrics of interest maintain such smoothness. One study considered the case of identifying unsafe system-level behaviors for cyber-physical systems without exploiting any information about, for example, switching dynamics.

The efficiency of BO heavily relies on the modeling capabilities of the statistical prior (or surrogate), and many techniques have been proposed to scale BO for heterogeneous function optimization by improving the surrogate. Some studies use non-stationary kernels to model the non-stationarity; however, these methods are complex and computationally intractable. Other studies warp the input space to a new space where the function is stationary and the standard BO framework is applied, but finding such a mapping is a different problem on its own. Further studies partition the input space to fit individual GP in each sub-region. However, none of these methods utilize the system's underlying structure for efficient sampling.

Many studies in the literature tackle this problem. These studies can be classified into three categories:

1. Locally stationary and partition-based approaches: One early work tackles modeling of heterogeneous functions by partitioning the input space with tree-based algorithms and using independent stationary GPs to model the underlying function. Other works propose Voronoi tessellation-based partitioning of the input space. Another work overcomes the modeling limitation of axis aligned partitions by using a support vector machine (SVM) based classifiers at each node of the tree. A further work uses an alternative kernel which is modeled as a convolution of fixed kernel with independent stationary kernel whose parameters vary over the sub regions of the space.

2. GPs with non-stationary kernels: Some studies used non-stationary kernels to model the heterogeneous function, including one which uses non stationary kernels with a input dependent kernel parameters and further models the parameter functions with a smooth stationary Gaussian process. However, the use of non-stationary kernel makes these methods complex and computationally intractable.

3. Warping or spatial deformation based methods: Some methods map the original input space to a new space where the process is assumed to be stationary, one such work uses composite GP to warp the input space.

The present disclosure outlines a novel tree-based Bayesian Optimization framework to optimize heterogeneous black-box functions where the heterogeneity is represented by a finite set of homogeneous functions defined over the sub-regions of the input space. The present disclosure improves upon the partition-based approaches mentioned above by additionally employing the underlying structure and allowing for information sharing across non-contiguous sub-regions where the locally stationary functions are from similar function classes. Specifically, we tackle two key subproblems: (i) Modeling and learning the structure of the heterogeneous functions using a Monte Carlo tree-based algorithm (i.e., including identifying partitions of the input space), followed by (ii) optimization of the heterogeneous black box function using a Bayesian optimization approach that uses the learned structure and a novel acquisition function (“Class-UCB”).

The present disclosure outlines a first step in the direction of improving analysis of systems that are characterized by a discrete and finite number of “classes” of behaviors. Notice that a single class may be represented by disconnected sets of the input space. In particular, given an input, it is assumed that the class and the closest class that the system can switch to can be both evaluated. Under this scenario, the existing partition-based methods can be extended to a family of heterogeneous functions adding the class information. A system outlined herein models homogeneous behavior classes by imposing that the GPs learnt within the sub-regions of the input space that belong to the same class have same kernel hyperparameters. These functions are often encountered in many real-world applications, where the class information can be accessed by learning a classifier using the features. The system implements a tree-based framework with information sharing across non-contiguous partitions that belong to same homogeneous behaviour class to better learn the GP models. Contributions of the present disclosure include:
A system implementing a novel Metropolis Hastings tree sampling algorithm to identify partitions of an input space, a ClassGP framework that models a heterogeneous function with class information using Gaussian Process, which can be encompassed within a tree-based optimization framework referred to herein as ClassBO.
Theoretical analysis-uniform error bounds are computed for the ClassGP framework and are compared with the error bounds achieved by standard GP.
Theoretical guarantees on the asymptotic performance of ClassBO.
Empirical analysis-extensive empirical evaluations of the model are provided and compared with other modeling techniques including empirical evaluation of ClassBO and comparisons against competing Bayesian optimization methods.

### 2. Setup and Notation

### 2.1 Definitions and Notation

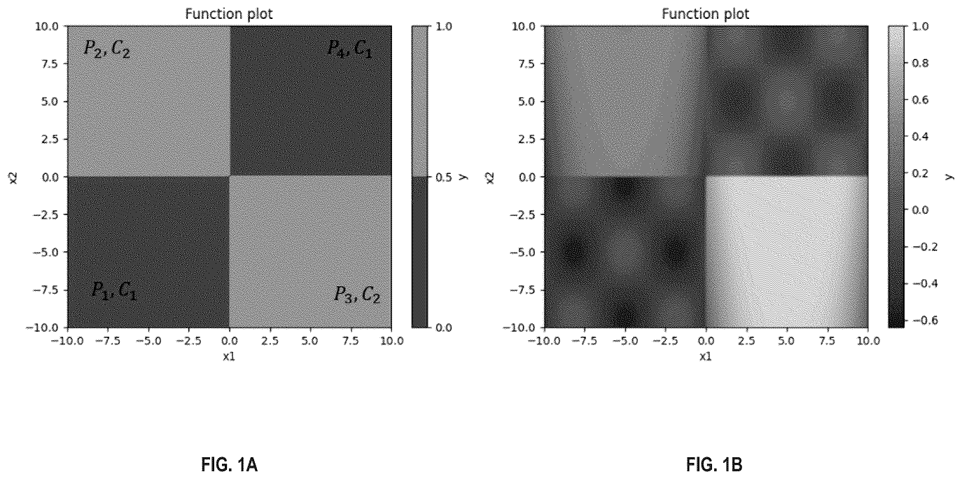

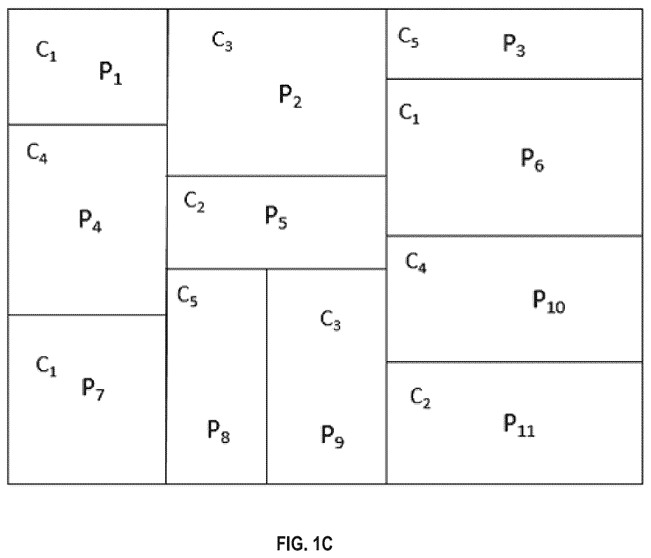

Let ƒ: [symbol] ⊆ [symbol] ^{d}→ [symbol] be a heterogeneous black-box function defined over a compact input space [symbol] such that the function ƒ can be represented by a finite set of homogeneous functions gⱼ's for all j∈[p] defined over with p axis aligned sub-regions (i.e., partitions) { [symbol] ⱼ}ⱼ₌₁^{p} of the input space. Further, each gⱼ is independently sampled from a Gaussian process with a continuous stationary kernel K, i.e., gⱼ˜ [symbol] [symbol] (μⱼ(.), κⱼ(.,.)). For notational convenience, and without loss of generality, the prior mean μⱼ=0. Additionally, multiple sub-regions (i.e., partitions) j₁, j₂∈[p] that belong to the same class i∈[m] include functions sampled from GPs with same covariance kernel function i.e., κⱼ_{₁}=κⱼ_{₂}=κᵢ. FIGS. 1A and 1B show an example of the heterogeneous function where the plot on the left shows the classes of the sub-regions and the plot on the right shows the homogeneous functions in each sub-region. The goal is to find the optimum of the heterogeneous function ƒ. The optimization problem is formally stated as follows:

$${arg max}_{x ∈ 𝒳} f ( x ) = {arg max}_{x ∈ 𝒳} ( {\sum }_{j = 1}^{p} \{ x ∈ {j}_{} \} {g}_{j} ( x ) ) . \qquad ( 1 )$$

For consistency, partitions are denoted with a subscript j and classes with subscript i, owing to this notation any variable with subscript i or j would refer to class or partition variable respectively.

Let [symbol] ᵢ denote all the partitions with class label i, i.e., [symbol] ᵢ=∪_{{j:} [symbol] _{(j)=i}} [symbol] ⱼ, this can be visualized with the help of an example as shown in FIG. 1C. The function ƒ is formally given as follows:

$$f ( x ) = {\sum }_{j = 1}^{p} \{ x ∈ {j}_{} \} {g}_{j} ( x ) . \qquad ( 2 )$$

The observation model is such that evaluating the function at any point x reveals function evaluation (y), the class label ( [symbol] ), and the minimum distance to a boundary of sub-region (w), since the structure of non-stationarity can be evaluated for many engineering problems. A training data set [symbol] ={xₙ, yₙ, [symbol] ₙ, wₙ}ₙ₌₁^{N} where N is number of training data points. Also, X=[x₁, . . . , xₙ]^{T}, y, z are the vector of corresponding evaluations and classes respectively and W is a list of tuples of distance and feature index along which the distance is measured.

### 2.2 Computer-Implemented System

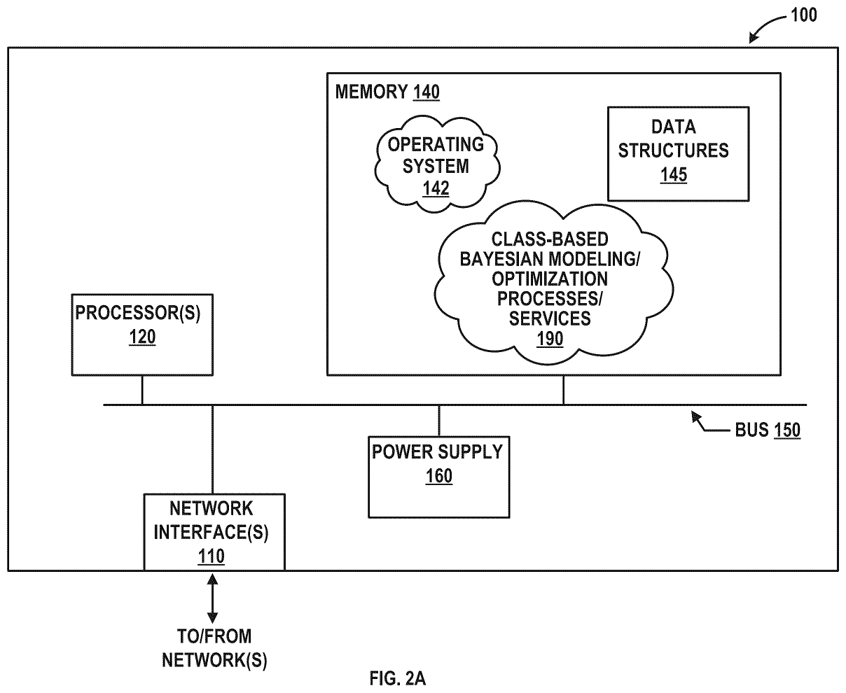

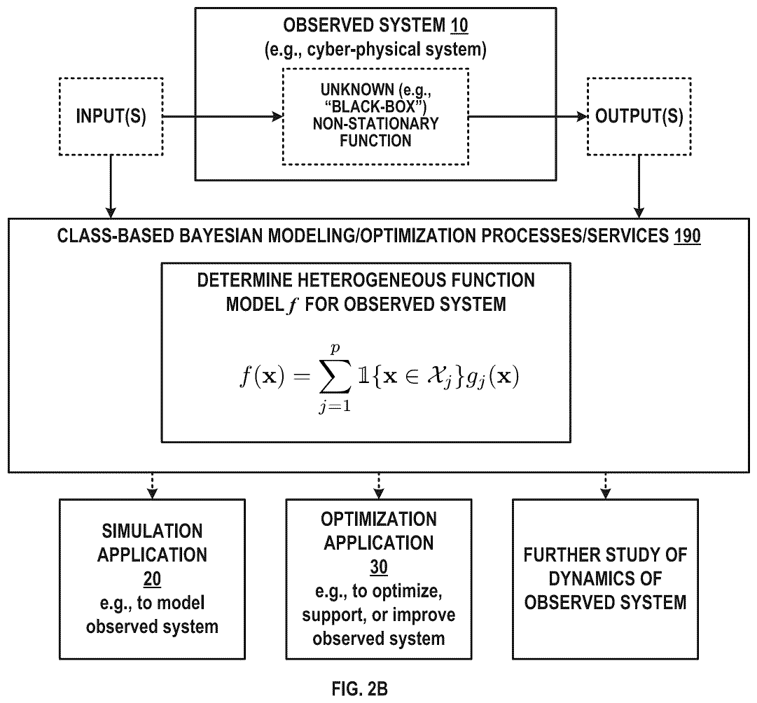

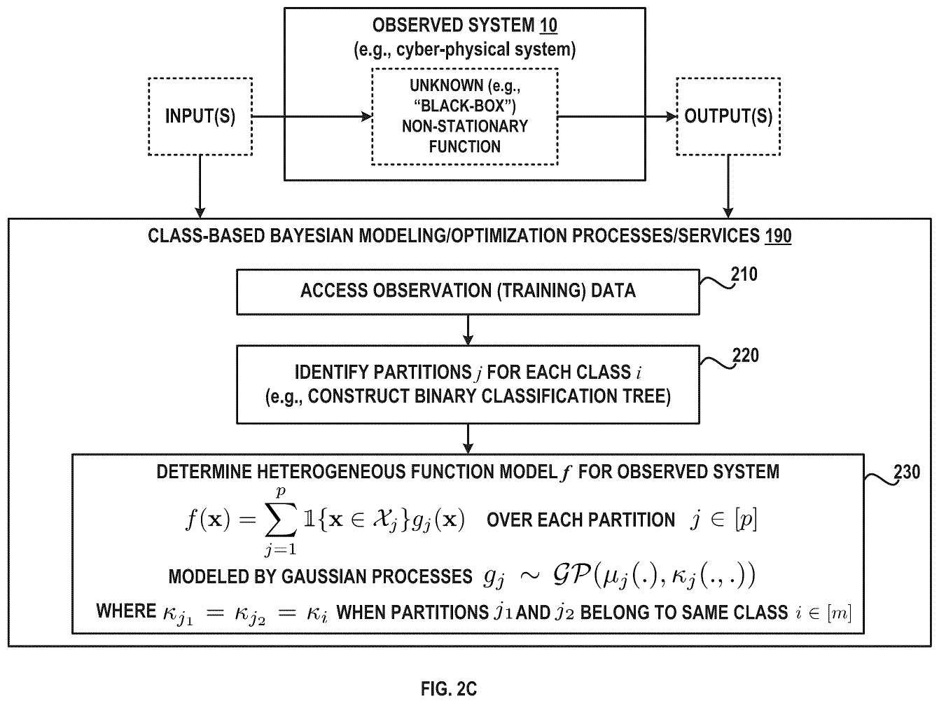

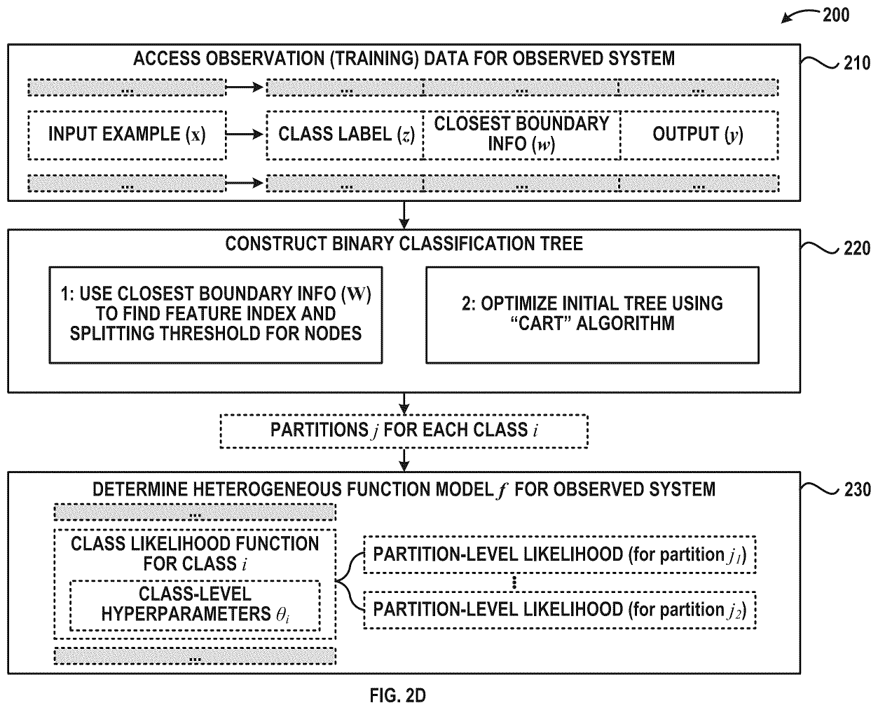

FIG. 2A is a schematic block diagram of an example system 100 that may be used with one or more embodiments described herein, e.g., as a component of a system implementing aspects of the ClassGP and ClassBO frameworks outlined herein.

System 100 comprises one or more network interfaces 110 (e.g., wired, wireless, PLC, etc.), at least one processor 120, and a memory 140 interconnected by a system bus 150, as well as a power supply 160 (e.g., battery, plug-in, etc.).

Network interface(s) 110 include the mechanical, electrical, and signaling circuitry for communicating data over the communication links coupled to a communication network. Network interfaces 110 are configured to transmit and/or receive data using a variety of different communication protocols. As illustrated, the box representing network interfaces 110 is shown for simplicity, and it is appreciated that such interfaces may represent different types of network connections such as wireless and wired (physical) connections. Network interfaces 110 are shown separately from power supply 160, however it is appreciated that the interfaces that support PLC protocols may communicate through power supply 160 and/or may be an integral component coupled to power supply 160.

Memory 140 includes a plurality of storage locations that are addressable by processor 120 and network interfaces 110 for storing software programs and data structures associated with the embodiments described herein. In some embodiments, system 100 may have limited memory or no memory (e.g., no memory for storage other than for programs/processes operating on the device and associated caches). Memory 140 can include instructions executable by the processor 120 that, when executed by the processor 120, cause the processor 120 to implement aspects of the ClassGP and/or ClassBO framework and associated methods (e.g., method 200 and/or method 400) outlined herein. In some examples, memory 140 can include non-transitory computer readable media including instructions encoded thereon that are executable by the processor 120 to implement aspects of the ClassGP and/or ClassBO framework and associated methods (e.g., method 200 and/or method 400) outlined herein.

Processor 120 comprises hardware elements or logic adapted to execute the software programs (e.g., instructions) and manipulate data structures 145. An operating system 142, portions of which are typically resident in memory 140 and executed by the processor, functionally organizes system 100 by, inter alia, invoking operations in support of software processes and/or services executing on the device. These software processes and/or services may include Class-based Bayesian Modeling/Optimization processes/services 190, which can include aspects of the methods and/or implementations of various modules described herein, particularly with respect to Section 4 herein including method 200 and method 400. Note that while Class-based Bayesian Modeling/Optimization processes/services 190 is illustrated in centralized memory 140, alternative embodiments provide for the process to be operated within the network interfaces 110, such as a component of a MAC layer, and/or as part of a distributed computing network environment.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules or engines configured to operate in accordance with the techniques herein (e.g., according to the functionality of a similar process). In this context, the term module and engine may be interchangeable. In general, the term module or engine refers to model or an organization of interrelated software components/functions. Further, while the Class-based Bayesian Modeling/Optimization processes/services 190 is shown as a standalone process, those skilled in the art will appreciate that this process may be executed as a routine or module within other processes.

### 3. Preliminaries

### 3A. ClassGP Preliminaries

This section gives a brief overview of Gaussian Process modeling and the classification tree algorithm used in the ClassGP framework.

### 3A.1 Gaussian Process Modeling

Gaussian process (GP) modeling is a popular statistical framework to model non-linear black box functions ƒ due to its analytical tractability of posteriors. Within this framework the function, ƒ: [symbol] ⊆ [symbol] ^{d}→ [symbol] , being modeled is assumed to be a distributed as per a Gaussian process prior, formally written as follows:

$$f ∼ 𝒢 𝒫 ( μ ( . ) , κ ( . , . ) ) ,$$

GP is completely given by its mean μ(.) and covariance kernel κ(.,.), where for convenience, and without loss of generality, the mean function μ(.) is set to 0. The choice of the covariance kernel depends on the degree of smoothness warranted by the function being modeled and is defaulted to stationary kernels such as squared exponential (SE) kernel or Matérn kernel. Functions modeled within this framework are typically assumed to be stationary, i.e., function can be modeled using a same stationary covariance function over the entire input space.

Learning a GP model involves computing a posterior conditioned on the observed data and learning kernel hyperparameters. Let [symbol] ₙ:{(x₁,y₁) . . . (xₙ,yₙ)} be the sampled training data of the objective function ƒ. The posterior of the function ƒ conditioned on the training data [symbol] ₙ is given by a Gaussian distribution i.e., ƒ(x)| [symbol] ₙ˜ [symbol] (μₙ(x),σₙ²(x)), where the mean μₙ(x) and covariance σₙ²(x) are given as follows:

$${μ}_{n} ( x ) = {k}^{T} {K}^{- 1} y and {σ}_{n}^{2} ( x ) = κ ( x , x ) - {k}^{T} {K}^{- 1} k \qquad ( 3 )$$

Here, y is the vector of noise free observations, k is a vector with kₚ=κ(x, xₚ). The matrix K is such that K_{p,q}=κ(xₚ,x_{q})p,q∈{1, . . . , n}.

The hyperparameters of the model are learnt by maximizing the log marginal likelihood which is given as follows:

$$log p ( y \vert X , θ ) = - \frac{1}{2} {y}^{T} {K}^{- 1} y - \frac{1}{2} log \vert K \vert - \frac{n}{2} log 2 π \qquad ( 4 )$$

and θ*=arg max_{θ}, log p(y|X,θ), this optimization problem is solved using off the shelf non convex optimization packages such as Dividing Rectangles (DIRECT), LBGFS, CMA-ES.

### 3A.2 Classification Tree Algorithm

A classification tree (also referred to as a decision tree classifier) is a binary tree algorithm which yield axis-aligned partitions of the input space by recursively partitioning the input space on one dimension (feature) at a time. The classification tree is “learnt” from the training data and the predictions for any input x are given by traversing the learnt tree from root node to a leaf node. Notice that each leaf node corresponds to a partition of the input space.

In some examples, CART algorithm is used to grow/learn the tree. During training, the goal is to select the best feature and splitting threshold that minimizes the weighted impurity metric of the children nodes. Many tree-based algorithms typically use Gini index as the impurity metric to grow the tree, which is given as follows:

$$Gini index = 1 - {\sum }_{i = 1}^{n} {( {p}_{i} )}^{2} \qquad ( 5 )$$

where pᵢ is the probability of a given class at a given node. The recursion is continued until one of the stopping criterion is met or no further improvement in the impurity index is achievable. Typical choice of stopping criterion include maximum depth of the tree, minimum number of samples in a leaf, maximum number of leaf/partitions.

### 3B. Class BO Preliminaries

Standard BO uses a Bayesian statistical model typically Gaussian process to model the objective function and an acquisition function to navigate the input space efficiently.

Bayesian statistical model (prior) formulates a distribution over the space of objective functions which is then used to compute the posterior over the set of observations. A Gaussian process (GP) prior is used in general due to its analytical tractability to evaluate the posterior, i.e., as Class GP outlined in Section 4A. The GP prior is completely given by its mean function μ(.), and covariance function κ_{θ}(.,.) i.e.,

$$f ∼ 𝒢 𝒫 ( μ ( . ) , {κ}_{θ} ( . , . ) ) .$$

here, θ represents the (unknown) hyperparameters (length scales) of the model and w.l.o.g, the mean function μ(.) is set to 0. For the set of noisy observations [symbol] ₙ: {(x₁,y₁) . . . (xₙ,yₙ)}, where the noise is i.i.d. Gaussian with variance σ², the posterior on the data [symbol] ₙ at any new point in the input space is given by a Gaussian distribution. i.e., ƒ(x)| [symbol] ₙ˜ [symbol] (μₙ(x),σₙ²(x)), with the mean μₙ(x) and variance σₙ²(x) given by the following closed form expressions:

$${μ}_{n} ( x ) = {{k}^{T} ( K + {σ}^{2} {I}_{n} )}^{- 1} Y ,$$

$${σ}_{n}^{2} ( x ) = κ ( x , x ) - {{k}^{T} ( K + {σ}^{2} {I}_{n} )}^{- 1} k .$$

Here, Y is observation vector, k is a vector with kₛ=κ_{θ}(x, xₛ), the matrix K is such that K_{s,t}=κ_{θ}(xₛ,xₜ) for all s,t∈{1, . . . , n}. The hyperparameters θ of the model are usually estimated by maximising the log marginal likelihood (MLE) which is given as follows:

$$\begin{matrix}log p ( y \vert X , θ ) = ( - \frac{1}{2} {{y}^{T} ( K + {σ}^{2} {I}_{n} )}^{- I} y \\ - \frac{1}{2} log \vert ( K + {σ}^{2} {I}_{n} ) \vert - \frac{n}{2} log 2 π ) .\end{matrix} \qquad ( 6 )$$

$$and$$

$$θ *= arg {max}_{θ} log p ( y \vert X , θ ) .$$

An Acquisition function uses information from past observed samples to efficiently navigate the input space by leveraging both mean and uncertainty estimates of the posterior. Most widely used acquisition functions are Upper Confidence Bound (UCB) and Expected Improvement (EI). In some examples outlined herein, an example UCB acquisition function can be given as follows:

$${a}_{n} ( x ) : = {μ}_{n} ( x ) + {β}_{n + 1}^{1 / 2} {σ}_{n} ( x ) .$$

Here, β is a hyperparameter that controls the trade-off between exploration and exploitation.

### 4. Framework

### 4A. ClassGP

This section introduces ClassGP for implementation by the systems outlined herein to model an observed system as a family of heterogeneous functions as defined in sections 2 and 3, as well as FIGS. 1C, 2A-2D, 3A and 3B. Within this framework, two sub-problems can be solved: 1) learning partitions of the input space to an observed system using closest boundary information W along with class information z; and 2) determining a heterogeneous (non-stationary) function model for the observed system as a family of stationary functions modeled as a Gaussian Process within each partition such that GPs of the partitions that share the same class label also share the same set of hyperparameters. Both noiseless and noisy function evaluations can be considered. Further, this framework can also be extended to other partitioning methods that can use closest boundary information.

FIG. 2B is a simplified block diagram showing an observed system 10 such as a cyber-physical system or other interconnected system whose dynamics need to be modeled. The dynamics of the observed system 10 can be considered as an unknown (e.g., black-box) non-stationary function which takes inputs (i.e., parameter values such as control inputs) and results in outputs (i.e., control output values, actuation values, physical outputs, etc.). As discussed in section 2, the input space [symbol] ⊆ [symbol] ^{d} can be a compact space with p axis aligned partitions { [symbol] ⱼ}ⱼ₌₁^{p} and each partition j∈[p] is assigned a class label i∈[m] i.e., = [symbol] (j)=i, referred to as class−partition space. The class labels may be known, and the partitions (i.e., as subsets of the classes) can be unknown. The unknown function of the observed system 10 can be modeled as a family of non-stationary functions ƒ defined over class-partition space, ƒ: [symbol] → [symbol] , such that ƒ boils down to a stationary functions gⱼ over each partition j∈[p] where each gⱼ is sampled from a Gaussian process with a continuous stationary kernel κⱼ i.e., gⱼ˜ [symbol] [symbol] (μⱼ(.),κⱼ(.,.)). Importantly, partitions j₁, j₂ that belong to same class i can have same covariance kernel i.e., κⱼ_{₁}=κⱼ_{₂}=kᵢ.

The Class-based Bayesian Modeling/Optimization processes/services 190 can be implemented by the system 100 to develop a heterogeneous function model ƒ for the observed system 10 based on observation data obtained from the observed system 10 (i.e., training data), where individual stationary functions gⱼ over each partition j∈[p] can be sampled from a Gaussian process with a continuous stationary kernel κⱼ. As further shown, the output of the system 100 can be used in downstream applications, such as but not limited to simulation (e.g., simulation application 20) to simulate the observed system 10 using the heterogeneous function model ƒ. This can help researchers, designers, and engineers by providing a more accurate model for simulating the observed system. The output of the system 100 can also be used for optimization (e.g., optimization application 30) which can help researchers, designers, and engineers optimize aspects of a system or supporting structure that depends on, affects, or is affected by the dynamics of the observed system 10. Other practical uses of the output of the system 100 outlined herein can include further study of the observed system 10, including understanding the dynamics of the observed system 10 based on how the system behaves and how individual partitions and classes contribute to behavior of the observed system 10.

Referring to step 210 of a method 200 shown in FIGS. 2C and 2D, the system 100 (implementing Class-based Bayesian Modeling/Optimization processes/services 190) can access observation data as training data, which can include: a set of closest boundary information for a plurality of input examples to the observed system 10: a class label associated with an input example of the plurality of input examples, the class label being one of a plurality of class labels; and an output example of the physical system that correlates with the input example. The set of closest boundary information can include: a minimum distance of the input example from a partition of the observation data; and a feature index associated with the minimum distance and the partition.

As further shown at step 220 of the method 200 of FIGS. 2C and 2D, the system 100 (implementing Class-based Bayesian Modeling/Optimization processes/services 190) can determine a plurality of partitions for a class label of the plurality of class labels of the observation data for the observed system 10 using the set of closest boundary information. This can be achieved by constructing a binary classification tree using the set of closest boundary information. The binary classification tree includes a plurality of leaf nodes, each leaf node of the plurality of leaf nodes respectively corresponding to a partition of the plurality of partitions. The binary classification tree is constructed using the available class label information to identify the partitions of the input space, where each sub-region of input space corresponds to a leaf and is has an assigned class label to it.

At step 230 of the method 200 of FIGS. 2C and 2D, the system 100 can determine the heterogeneous function model for the observed system 10 based on the observation data and the plurality of partitions. The heterogeneous function model for the observed system 10 incorporates a class likelihood function for each class label of the plurality of class labels, which in turn incorporates partition-level log marginal likelihoods for the plurality of partitions of the class label. This can include determining a class-level hyperparameter of the class likelihood function for the class label by joint optimization of the partition-level log marginal likelihoods for the plurality of partitions of the class label. The class likelihood function can incorporate a summation of partition-level log marginal likelihoods for the plurality of partitions of the class label. Each partition of the plurality of partitions of a class label can respectively be associated with an underlying partition-level stationary function (gⱼ) modeled using a Gaussian process prior having a continuous stationary kernel (κⱼ), the continuous stationary kernel (κⱼ) being applicable for (or otherwise common to or shared by) each partition of the plurality of partitions that share the class label.

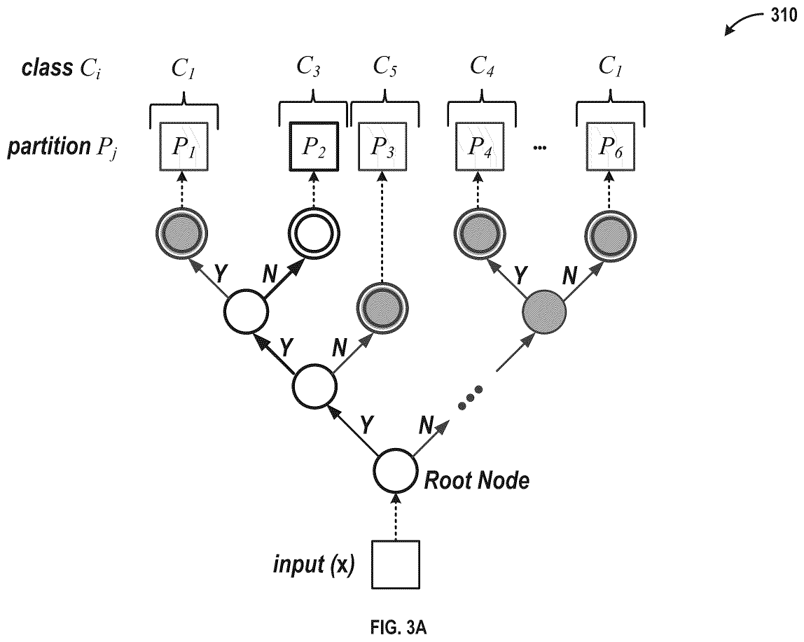

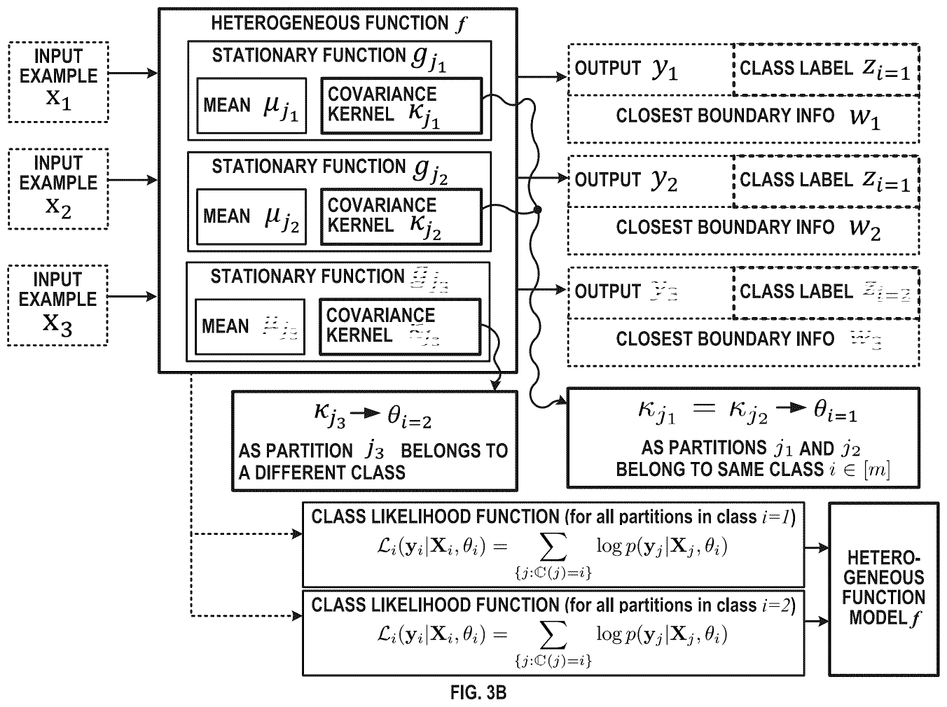

The binary classification tree is further elaborated on in FIG. 3A and section 4A.1 of the present disclosure. Steps associated with determining the heterogeneous function model expressive of dynamics of the observed system 10 are further elaborated on FIG. 3B and Section 4A.2 of the present disclosure.

### 4A.1 Learning Partitions

A decision tree algorithm tailored for the framework is used to learn the partitions of the input space. The decision tree algorithm implemented by the system “learns” or otherwise constructs a binary classification tree in two or more sub-steps as shown in step 220 of the method 200 of FIG. 2D: while sub-steps 1 and 2 involve use of recursive binary splitting to grow the decision tree, sub-step 1 includes using closest boundary information W to find the best feature index and splitting threshold for each node of the binary classification tree that maximize reduction of Gini index (or any other suitable impurity metric) until all the closest boundary information W is exhausted. Sub-step 2 includes selecting the best feature index and splitting threshold that maximize reduction of the impurity metric (e.g., Gini index) from available training data at each node. The second sub-step can be implemented using the CART algorithm as in section 3A.2. The nodes are recursively split until a stopping criterion is satisfied. In one implementation of the system outlined herein, Gini index is used for the impurity metric and minimum number of samples at the leaf node and max depth are used as stopping criterion.

FIG. 3A shows an example of a binary classification tree 310, including a “root” node and a plurality of “leaf” nodes. The “leaf” nodes correspond to individual partitions, where more than one partition can belong to a class. In the example of FIG. 3A (where partitions and classes correspond to the input space example in FIG. 1C), two separate leaf nodes are shown corresponding to partitions 1 and 6, where both partitions 1 and 6 correspond to class 1. To determine a partition for a given input (x) to the observed system 10, a classification process starts at a root node which results in a binary output (e.g., “yes” or “no”) and traverses the binary classification tree 310 until arriving at a leaf node which corresponds to the partition. The binary classification tree is constructed using the available class label information to identify the partitions of the input space, where each sub-region of input space corresponds to a leaf and is has an assigned class label to it.

In a non-limiting illustrative example corresponding to an automatic transmission within a vehicle being the observed system 10, where partitions correspond to individual gears that the transmission could switch to, an input instance to the observed system 10 could include a current ground speed of the vehicle, a current gear, and/or an engine speed (e.g., RPM). For the root node, consider an example where a feature index obtained during construction of the binary classification tree 310 could start with the current gear, and a splitting threshold could be “3^{rd} gear or higher”. If the input instance indicates that the vehicle is in 3^{rd} gear or higher, then a “yes” pathway can be selected which leads to a first child node. If not, then a “no” pathway can be selected which leads to a second child node. Continuing with the example, consider that the “yes” pathway at the root node is taken leading to the first child node. For the first child node, a feature index could be the same feature (e.g., directed to which gear the vehicle is currently in) but with a different splitting threshold (e.g., “5^{th} gear or higher) which can isolate higher gears from medium gears. Alternatively, the first child node can be directed to a different feature (e.g., directed to a current engine speed) having a splitting threshold (e.g., higher or lower than a certain RPM value). The binary splitting process can continue recursively along the length of the binary classification tree 310 until a leaf node is reached which can correlate with a partition within a class.

### 4A.2 Gaussian Process in Each Partition

The partitions of the input space learnt from the decision tree algorithm in section 4A.1 are used to divide the training data set [symbol] into partition-based subsets [symbol] ⱼ with nⱼ data points for all j∈[p]. Referring to FIG. 3B, for each partition [symbol] ⱼ underlying stationary function gⱼ is modeled using a zero mean Gaussian Process prior with continuous stationary kernel κⱼ(.,.) and subset of training data [symbol] ⱼ is used to learn/train the model. The function modeling and training in each partition can be similar to that of a standard Gaussian process regression problem with the exception of learning the hyperparameters of the partition GPs. The posterior of partition GP conditioned on the partition training data is given by y(x)|x,j, [symbol] ⱼ˜ [symbol] (μ_{j,n}_{ⱼ}(X),σ_{j,n}_{ⱼ}² (x)) where mean μ_{j,n}_{ⱼ}= [symbol] (y|x,j, [symbol] ⱼ) and variance σ_{j,n}_{ⱼ}² are given as follows:

$${μ}_{j , {n}_{j}} ( x ) = {k}_{j}^{T} {K}_{j}^{- 1} {y}_{j} and {σ}_{j , {n}_{j}}^{2} ( x ) = {κ}_{j} ( x , x ) - {k}_{j}^{T} {K}_{j}^{- 1} {k}_{j}$$

where yⱼ is the vector of observations in given partition j, kⱼ is the vector with kⱼ^{(s)}=κⱼ(x,xₛ). The matrix Kⱼ is such that Kⱼ^{(s,t)}=κⱼ(xₛ,xₜ) where s,t∈{1, . . . , nⱼ}. Note the superscripts here represent the components of the vector and matrix.

Learning hyperparameters in a standard GP typically involves finding the set of hyperparameters that maximize the log marginal likelihood of the observations (eq. 4), whereas in the current framework the set of hyperparameters need to maximize the log marginal likelihood across all the partitions within a class. As such, a method of learning hyperparameters by the system is outlined herein.

Each partition of the plurality of partitions of the class label can respectively have an underlying partition-level stationary function (gⱼ) modeled using a Gaussian process (GP) prior distribution having a continuous stationary kernel (κⱼ), the continuous stationary kernel (κⱼ) being applicable for each partition of the plurality of partitions of the class label. A new class likelihood is formed as a summation of log marginal likelihoods of all partition GPs for a given class. Class kernel hyperparameters are learnt by joint optimization (e.g., maximization) of the partition-level log marginal likelihoods for the plurality of partitions of the class label. The formulation of the class-likelihood function assumes that the data from different partitions are independent of each other but can still be combined into the class-likelihood function, and this reduces the computational complexity of learning the hyperparameters significantly while still taking data from all the partitions in the class.

The extensive empirical results show that this new class likelihood reduces the modelling error and provides with the better estimates of the hyperparameters, intuitively this makes sense as there are more data points to estimate hyperparameters even though all the data points do not belong to the same partition. The new class likelihood function for a given class i is given as follows:

$${ℒ}_{i} ( {y}_{i} \vert {X}_{i} , {θ}_{i} ) = {\sum }_{\{ j ℂ ( j ) = i \}} log p ( {y}_{j} \vert {X}_{j} , {θ}_{i} ) = - \frac{1}{2} {y}_{i}^{T} {K}_{i}^{- 1} {y}_{i} - \frac{1}{2} log \vert {K}_{i} \vert - \frac{{n}_{i}}{2} log 2 π$$

where θ*ᵢ=argmax_{θ}_{ᵢ} [symbol] ᵢ(yᵢ|Xᵢ, θᵢ), Kᵢ is the block diagonal matrix with blocks of Kⱼ for all {j: [symbol] (j)=i}, nᵢ=Σ_{{j:} [symbol] _{(j)=i}} nⱼ, and yᵢ is the vector formed by yⱼ for all {j: [symbol] (j)=i}.

In FIG. 3B, consider a first input example x₁, a second input example x₂, and a third input example x₃ which can be applied as input to the heterogeneous function ƒ. The first input example x₁ can belong to a first partition j₁, the second input example x₂ can belong to a second partition j₂, and the third input example x₃ can belong to a third partition j₃. Evaluation of the heterogeneous function ƒ based on the first input example x₁ results in: an output y₁, class information z including class label zᵢ₌₁, and closest boundary info w₁ for the first input example x₁. Evaluation of the heterogeneous function ƒ based on the second input example x₂ results in: an output y₂, class information z including class label zᵢ₌₁, and closest boundary info w₂ for the second input example x₂. Further, evaluation of the heterogeneous function ƒ based on the third input example x₃ results in: an output y₃, class information z including class label zᵢ₌₂, and closest boundary info w₃ for the third input example x₃. Note that despite belonging to different partitions, both the first input example x₁ and the second input example x₂ can correlate with the same class i=1; however, the third input example x₃ correlates with a different class i=2.

A heterogeneous function model ƒ for the observed system can include, for the first partition j₁, a first partition-level stationary function gⱼ_{₁} having a mean μⱼ_{₁} and a first covariance kernel κⱼ_{₁} (which can include several hyperparameters). Likewise, the heterogeneous function model ƒ for the observed system can include, for the second partition j₂, a second partition-level stationary function gⱼ_{₁} having a mean μⱼ_{₂} and a second covariance kernel κⱼ_{₂} (which can likewise include several hyperparameters). Because the first input example x₁ associated with the first partition j₁ and the second input example x₂ associated with the second partition j₂ can both correlate with the same class i, the first covariance kernel κⱼ_{₁} and the second covariance kernel κⱼ_{₂} can be set equal to one another, e.g., as class covariance kernel κᵢ₌₁, which can be considered a class-level hyperparameter θᵢ₌₁.

Further, for the third partition j₃, the heterogeneous function model ƒ for the observed system can include a third partition-level stationary function gⱼ_{₃} having a mean μⱼ_{₃} and a third covariance kernel κⱼ_{₃} (which can include several hyperparameters).

Because the third input example x₃ for the third partition j₃ belongs to a class i=2 which is different from that of the first partition j₁ and the second partition j₂, the third covariance kernel κⱼ_{₂} can be considered as class covariance kernel κᵢ₌₂, which can be considered a class-level hyperparameter θᵢ₌₂ and can differ from the first covariance kernel κⱼ_{₁} and the second covariance kernel κⱼ_{₂}.

The heterogeneous function model ƒ can be constructed from class likelihood functions for each class of the plurality of classes, which are themselves constructed from partition-level likelihood functions from partitions within their respective class (where the partition-level likelihood functions correspond with their associated Gaussian Process priors or stationary functions, i.e., gⱼ_{₁}, gⱼ_{₂}, gⱼ_{₃}). In the example of FIG. 3B showing two classes, the heterogeneous function model ƒ can include a first class likelihood function for class i=1 and a second class likelihood function for class i=2.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### 4B. ClassBO

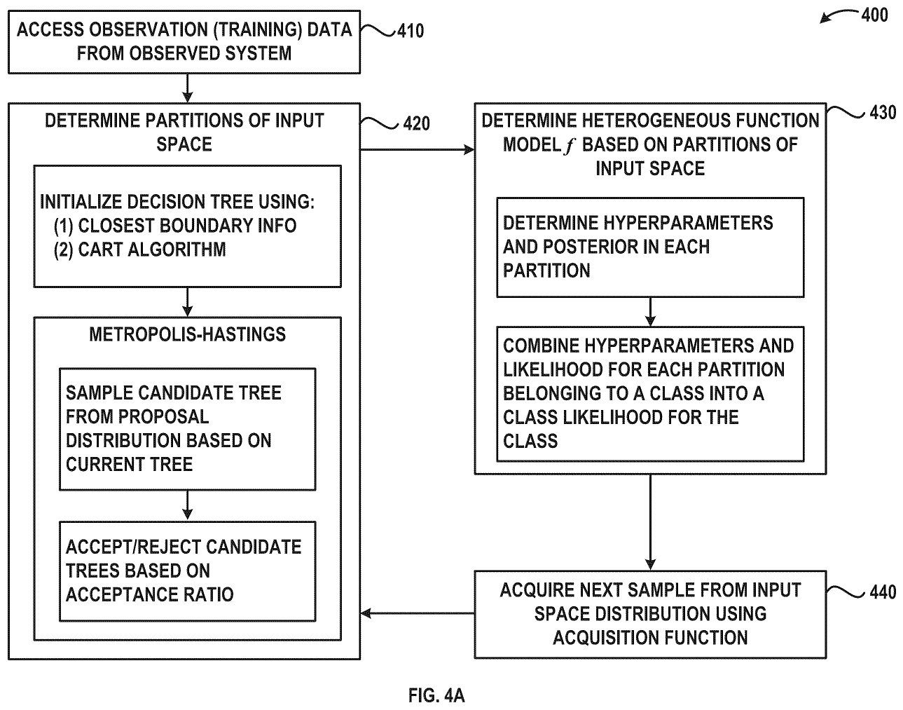

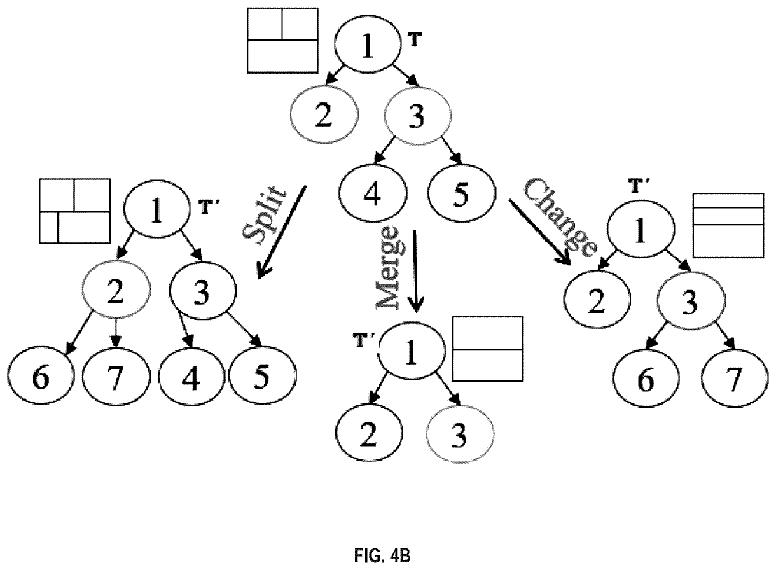

Referring to FIG. 4A, ClassBO optimizes the family of heterogeneous functions as defined in section 4A (pertaining to ClassGP) by iterating between two steps: (i) partition sampling for learning the structure of the input space using a decision tree algorithm to formulate the initial binary classification tree based on distance information (i.e., closest boundary information W) followed by a Metropolis-Hastings sampling scheme to sample from the space of tree posterior conditioned data; and (ii) Location sampler implements a Bayesian optimization search using the ClassGP model (of sections 3A and 4A) to learn black box functions whose heterogeneity can be encoded by means of a partition, and further uses a ClassUCB acquisition function to sample from ClassGP. This section provides the details for ClassBO and its components.

FIG. 4A shows a method 400 associated with ClassBO which is similar to method 200 associated with ClassGP but with additional steps for refining the binary classification tree (denoted as “decision tree” within the figure for brevity) and efficiently navigating the sampling space. Step 410 of method 400 includes accessing observation (training) data from an observed system. Step 420 of method 400 includes determining the partitions of the input space. This can be achieved by initializing the binary classification tree as outlined above with respect to ClassGP using (1) closest boundary information; and (2) the CART algorithm. Further, step 420 of method 400 can include iteratively implementing a Metropolis-Hastings sampling scheme to further refine the binary classification tree conditioned on the observation data. The Metropolis-Hastings sampling scheme can include sampling “candidate” trees from a proposal distribution based on a current tree (i.e., an initial binary classification tree found using closest boundary info and CART, and/or a previous tree that was accepted by a previous iteration of the Metropolis-Hastings sampling scheme) and accepting or rejecting the candidate trees based on an acceptance ratio. Following determination of the partitions of the input space, step 430 of method 400 can include determining the heterogeneous function model ƒ based on partitions of the input space, including determining hyperparameters and posteriors in each partition and combining the hyperparameters and likelihoods for each partitions belonging to a class into a class likelihood for the class, similar to that of step 230 in FIGS. 2B-2D. Following step 430, step 440 of method 400 can include acquiring or otherwise sampling a next input example from the input space distribution of the heterogeneous function model for the observed system using an acquisition function. Steps of method 400 can be iteratively repeated until a stop criterion is reached. Algorithm 1 gives a pseudo code for ClassBO.

Algorithm 1: ClassBO Algorithm

| | |
|---|---|
| 1: | Observe f at t₀ > 0 points. |
| 2: | Set t = t₀, [symbol] ₜ = {((x₁, y₁), ... , (xₜ > yₜ))} |
| 3: | while t ≤ T do |
| 4: | Learn the partitions of input space - Decision tree and MH tree sampler |
| 5: | Compute the hyperparameters and posterior in each sub-region gⱼ \| [symbol] _{j,t}_{ⱼ}∀ⱼ |
| 6: | Find Xₜ₌₁ = arg [symbol] aₜ(x) (ClassUCB acquisition function). |
| 7: | Observe yₜ₊₁ = f (xₜ₊₁) + ϵₜ₊₁ · ( [symbol] (0, η²) |
| 8: | [symbol] ₜ₊₁ = [symbol] t ∪ {(xₜ₊₁, yₜ₊₁)} |
| 9: | Increment t |
| 10: | end while |
| 11: | Return the point xᵢ with largest yᵢ |

### 4B.1 Partition Sampling

As discussed above with respect to step 420 of method 400, partition sampling for ClassBO involves two key steps learning the initial partitions of the input space based on distance information using a decision tree algorithm (similar to sub-steps 1 and 2 of step 220 shown in FIG. 2D, and as discussed in sections 3A and 4A pertaining to ClassGP herein), followed by Metropolis Hastings based tree sampler with the tree learnt from decision tree algorithm as initialization to sample a tree from the space of tree posterior conditioned on the data. FIG. 4B shows an example of modifying or otherwise refining the initial binary classification tree learned using the decision tree algorithm of ClassGP.

Decision tree (CART) algorithm “learns” a tree T by executing recursive binary splits on the data by selecting the feature and the splitting threshold that provides the maximum reduction in the impurity (which can be measured as Gini index). To reiterate, Gini impurity index used in this work is given as follows:

$$Gini index = 1 - {\sum }_{i = 1}^{n} {( {p}_{i} )}^{2} ,$$

where pᵢ is the probability of a given class at a given node. Notice that each leaf nodes of the tree correspond to a sub-regions of the input space. A tree can be represented with T, interior nodes indexed by η∈{1, . . . , u}, leaf nodes indexed by j∈{1, . . . , v} where u is the total number of interior nodes and v is total number of leaf nodes in the tree T.

ClassBO can use the modified decision tree algorithm of ClassGP to learn the sub-regions (i.e., partitions) of the input space based on the distance information. Specifically, ClassBO uses the distance to the closest boundary information W for selecting the features and splitting threshold to form an initial tree in each iteration of ClassBO algorithm (as in sections 3A and 4A pertaining to ClassGP). The partitioned sub-regions (leaf nodes) of the input space are assigned class labels based on the maximally observed sample class in the given sub-region.

ClassBO can employ a Metropolis Hastings (MH) based tree sampling algorithm to account for the uncertainty in the initial tree from steps 1 and 2 of the decision tree algorithm of ClassGP. MH algorithm is a Markov chain Monte Carlo method to sample from a target distribution when direct sampling is difficult.

MH tree sampler uses tree learned from decision tree algorithm as initialization and uses proposal distribution to sample candidate tree from the posterior. A MH tree sampler can be formulated by defining: (i) a target distribution on the space of trees p(T| [symbol] ), (ii) a proposal distribution with transition kernel q(T, T′) to generate tree candidates and (iii) an acceptance ratio A(T, T′) to accept of reject the candidate trees.

### 4B.1.1 Tree Prior

An implicit tree prior can be specified on the space of trees. Specifically, a stochastic process is defined for generating trees and each realization of this tree generating process is a random sample from the prior p(T). The tree generating process starts with an initial tree T₀. The tree is then grown randomly by spitting each leaf node (j) where the leaf node can be split with a probability pₛₚₗᵢₜ, followed by assigning a splitting rule with probability pᵣᵤₗₑ. The present disclosure outlines a split probability function dependent on the depth of the node, given as follows:

$${p}_{split} ( j , T ) = {α ( 1 + {d}_{j} )}^{- β} ,$$

where dⱼ is the depth of the node j, and α,β>0 are user defined tunable parameters. A splitting rule is assigned to the splitting node by uniformly selecting a feature to split followed by uniformly selecting the threshold to split on the feasible range.

### 4B.1.2 Proposal Distribution

The proposal distribution generates the candidate tree T′ given the current tree T. As illustrated in FIG. 4B, the transition kernel q(T, T′) generates tree candidates by randomly selecting one of the following operations with uniform probability:
Split: Uniformly pick a leaf node. Split the leaf node by assigning a rule such that the class labels of children nodes are different.
Merge: Uniformly pick a node whose children are leaf nodes. Merge the children nodes to turn the parent node into a leaf node.
Change: Uniformly pick a node whose children are leaf nodes and reassign a new random rule such that the class labels of the children nodes are different.

### 4B.1.3 Acceptance Ratio

The acceptance ratio A (T, T′) to accept or reject the generated tree candidate is given as follows:

$$A ( T , {T}^{′} ) = min ( \frac{p ( {T}^{′} ) p ( 𝒟 \vert {T}^{′} ) q ( T , {T}^{′} )}{p ( T ) p ( 𝒟 \vert T ) q ( {T}^{′} , T )} , 1 )$$

Notice that it is not necessary to compute p(T) or p(T′). Instead, the ratio p(T′)/p(T) can be computed which is only dependent on pₛₚₗᵢₜ, pᵣᵤₗₑ.

### 4B.2 Location Sampling

ClassBO uses ClassGP as outlined in sections 3A and 4A herein to model the target function, where the sub-regions (i.e., partitions) of the input space learned based on the binary classification tree divide the training data set [symbol] into sub-regions denoted by subsets [symbol] ⱼ with nⱼ data points for all j∈[p]. For each sub-region [symbol] ⱼ, the underlying stationary function gⱼ can be modeled using a zero mean Gaussian Process prior with continuous stationary kernel κⱼ( . . . ). The subset [symbol] ⱼ is used to compute the posterior for the sub-region j. The computation of the posterior is similar to that of the standard GP regression with one exception of learning the hyperparameters for each sub-region. The conditional GP posterior for a sub-region j is given by y(x)|x,j, [symbol] ⱼ˜ [symbol] (μ_{j,n}_{ⱼ}(x), σ_{j,n}_{ⱼ}²(x)) where mean μ_{j,n}_{ⱼ} and variance σ_{j,n}_{ⱼ}² given as follows:

$${μ}_{j , {n}_{j}} ( x ) = {k}_{j}^{T} {K}_{j}^{- 1} {y}_{j} ,$$

$${σ}_{j , {n}_{j}}^{2} ( x ) = {κ}_{j} ( x , x ) - {k}_{j}^{T} {K}_{j}^{- 1} {k}_{j}$$

where yⱼ is the vector of observations in given sub-region j, kⱼ is the vector kⱼ^{(s)}=κⱼ(x,xₛ), the matrix Kⱼ is such that Kⱼ^{(s,t)}=κⱼ(xₛ,xₜ) where s,t∈{1, . . . , nⱼ}. Note the superscripts here represent the components of the vector and matrix.

Learning hyperparameters in a standard GP involves maximizing the log marginal likelihood of the observations as shown in equation (6), whereas in order to share information across the sub-regions with same class labels the hyperparameters are learned by maximizing the log marginal likelihood across all the sub-regions that have same class label. The class likelihood as outlined in section 4A.2 formed by maximizing a summation of the log marginal likelihoods of GPs of all the sub-regions with a given class label to learn the hyperparameters. Intuitively, the new class likelihood makes sense as the sub-regions that have same class label have the same underlying homogeneous function. The new class likelihood function for a given class i is given as follows:

$${ℒ}_{i} ( {y}_{i} \vert {X}_{i} , {θ}_{i} ) = {\sum }_{\{ j : ℂ ( j ) = i \}} log p ( {y}_{j} \vert {X}_{j} , {θ}_{i} ) = - \frac{1}{2} {y}_{i}^{T} {K}_{i}^{- 1} {y}_{i} - \frac{1}{2} log \vert {K}_{i} \vert - \frac{{n}_{i}}{2} log 2 π = {\sum }_{\{ j : ℂ ( j ) = i \}} - \frac{1}{2} {y}_{j}^{T} {K}_{j}^{- 1} {y}_{j} - \frac{1}{2} log \vert {K}_{j} \vert - \frac{{n}_{j}}{2} log 2 π$$

where the set {j: [symbol] (j)=i} denotes all sub-regions j that have a class label i, Kᵢ is the block diagonal matrix with blocks of Kⱼ's, yᵢ is the vector formed by concatenating yⱼ for all {j: [symbol] (j)=i}, nᵢ=Σ_{{j:} [symbol] _{(j)=i}}nⱼ, and of θ*ᵢ=argmax_{θ}_{ᵢ} [symbol] ᵢ(yᵢ|Xᵢ,θᵢ).

### 4B.3 Acquisition Function

As discussed with respect to step 440 of method 400, ClassBO utilizes the statistical model learned over the sub-regions of the input space to formulate the ClassUCB acquisition function to navigate the input space efficiently. The next sampling point for each iteration is decided by maximizing the ClassUCB acquisition function given as follows:

$${a}_{n} ( x ) = ( {\sum }_{j = 1}^{p} \{ x ∈ {j}_{} \} {a}_{{n}_{j}} ( x ) ) ,$$

$${a}_{{n}_{j}} ( x ) = {μ}_{j , {n}_{j}} ( x ) + {β}_{n + 1}^{1 / 2} {σ}_{j , {n}_{j}} ( x ) .$$

Where aₙ_{ⱼ} is the UCB acquisition function of the sub-region j and the next sampling location is given by xₙ₊₁=arg max_{x∈} [symbol] aₙ(x). In each iteration, once the new data point is sampled the algorithm relearns the sub-regions of the input space followed by computing the posterior in each sub-region.

The functions performed in the processes and methods may be implemented in differing order. Furthermore, the outlined steps and operations are provided as examples, and some of the steps and operations may be optional, combined into fewer steps and operations, or expanded into additional steps and operations without detracting from the essence of the disclosed embodiments.

### 5. Analysis

### 5A. ClassGP Analysis

This section provides a formal statement for probabilistic uniform error bounds for ClassGP framework. These bounds are derived based on the assumption that each unknown function gⱼ is a sample from a Gaussian process with known kernel function κⱼ.

Theorem 1A. Consider an unknown function ƒ: [symbol] → [symbol] which induces p partitions on the input space, and is given as ƒ=Σⱼ₌₁^{p} [symbol] {x∈ [symbol] ⱼ}gⱼ where each gⱼ has a Lipschitz constant L_{g}_{ⱼ} on each compact set [symbol] ⱼ from which each gⱼ is sampled for all j∈[p]. Given nⱼ∈ [symbol] noisy observations yⱼ with i.i.d zero mean Gaussian noise in a given partition the posterior mean (μₙ_{ⱼ}) and standard deviation (σₙ_{ⱼ}) of the Gaussian Process conditioned on [symbol] ⱼ={Xⱼ, yⱼ} of the partition are continuous with Lipschitz constant

$${L}_{{μ}_{{n}_{j}}}$$

and modulus of continuity

$${ω}_{{σ}_{{n}_{j}}}$$

on [symbol] ⱼ such that:

$${L}_{{μ}_{{n}_{j}}} \leq {L}_{{κ}_{j}} \sqrt{{n}_{j}} ‖ {\hat{K}}_{j}^{- 1} {y}_{j} ‖ \qquad ( 7 )$$

$${ω}_{{σ}_{{n}_{j}}} ( r ) \leq \sqrt{2 r {L}_{{κ}_{j}} ( 1 + {n}_{j} ‖ {\hat{K}}_{j}^{- 1} ‖ {κ}_{j} ( x , {x}^{′} ) )} \qquad ( 8 )$$

where \hat{K}ⱼ=(Kⱼ+η²Iₙ_{ⱼ}).
Moreover, pick δⱼ∈(0,1), r∈ [symbol] ₊ and set:

$${β}_{j} ( r ) = 2 log ( \frac{M ( r , {j}_{}}{{δ}_{j}} ) \qquad ( 9 )$$

$${γ}_{j} ( r ) = ( {L}_{{μ}_{{n}_{j}}} + {L}_{{g}_{j}} ) r + \sqrt{β ( r )} {ω}_{{σ}_{{n}_{j}}} \qquad ( 10 )$$

then the following bound on each partition holds with probability 1−δⱼ:

$$\vert {g}_{j} ( x ) - {μ}_{{n}_{j}} ( x ) \vert \leq \sqrt{{β}_{j} ( r )} {σ}_{{n}_{j}} ( x ) + {γ}_{j} ( r ) , ∀ x ∈ {j}_{} \qquad ( 11 )$$

and the following bound on the entire input space holds with probability 1−δ where δ=Σⱼ₌₁^{p} [symbol] {x∈ [symbol] ⱼ}δⱼ i.e.,

$$\vert f ( x ) - {μ}_{n} ( x ) \vert \leq \sqrt{β ( r )} {σ}_{n} ( x ) + γ ( r ) , ∀ x ∈ . \qquad ( 12 )$$

Corollary 1. Given problem setup defined in Theorem 1, the following bound on L₁ norm holds with probability 1-8:

$${‖ f = {μ}_{n} ‖}_{1} \leq ζ {r}^{d} {\sum }_{j = 1}^{p} M ( r , {j}_{} ) ( \sqrt{{β}_{j} ( r )} {σ}_{{n}_{j}} ( x ) + {γ}_{j} ( r ) ) \qquad ( 13 )$$

where ζ is a non negative constant, δ=Σⱼ₌₁¹δⱼ and δⱼ=1−M(r, [symbol] )e^{-B}^{ⱼ}^{(r)/2}.

### 5B. ClassBO Analysis

This section analyzes the ClassBO algorithm under the assumption that the true partitioning of the input space (tree T) is known, and shows that the algorithm converges to the optimal value asymptotically. To restate the problem setup and assumptions that are used to analyze the algorithm: Let ƒ: [symbol] ⊆ [symbol] ^{d}→ [symbol] be an heterogeneous black-box function defined over a compact space [symbol] and let gⱼ's be the homogeneous functions in the sub-regions [symbol] ⱼ, ∀ⱼ∈[p].

$$f ( x ) = {\sum }_{j = 1}^{p} \{ x ∈ {j}_{} \} {g}_{j} ( x ) . \qquad ( 14 )$$

Let x*∈ [symbol] ⊆ [symbol] ^{d} be the unique optimal point. Querying the function returns a noisy observation yᵥ=ƒ(xᵥ)+ϵᵥ with i.i.d. ϵᵥ˜ [symbol] (0, σ²).

Assumption 1. The function in each sub-region is a sample from a Gaussian process i.e., gⱼ˜ [symbol] [symbol] (0,κⱼ(.,.))∀ⱼ∈[p] with the known kernel function κⱼ. This is equivalent to ƒ˜ [symbol] [symbol] (0,κⱼ(.,.)) where κ(x,x′)=Σⱼ [symbol] {x,x′∈ [symbol] }κⱼ(x,x′).

A mild assumption on the smoothness of ƒ is needed to make problem solvable:

Assumption 2. Let D⊂[0,r]^{d} be compact and convex, d∈N,r>0. The kernel κ(x,x′) satisfies the high probability bound on the derivatives of [symbol] [symbol] sample paths ƒ for some constants a,b>0 a.e.

$$ℙ ( {sup}_{x ∈ 𝒟} \vert \frac{\partial f}{{\partial }_{{x}_{i}}} \vert > L ) \leq a {e}^{- {( \frac{L}{b} )}^{2}} , i = 1 , 2 , … , d . \qquad ( 15 )$$

By this assumption, the Lebesgue measure for discontinuities of ƒ is, which holds true in this setup as the discontinuities would only occur along the boundaries of the sub-regions.

Assumption 3. For the purpose of analysis assume that sub-regions of the input space are known a priori.

Additional notations: Without loss of generality, assume that the maximum ƒ(x*) lies in sub-region j=1 i.e., ƒ(x*)=g₁(x*). At any instant t of the algorithm run, tⱼ is the number of times j^{th} sub-region is sampled, and Tⱼ is the total number of times j^{th} sub-region is sampled after T iterations of the algorithm. Hence, Σⱼ₌₁^{p}tⱼ=t and Σⱼ₌₁^{p}Tⱼ=T. The regret rₜ at iteration t when the sub-region j is sampled is represented by r_{j,t}_{ⱼ}.

The analysis of the algorithm is divided into two parts, first when the decision set [symbol] ⱼ is finite for all partition index j∈[p] and then we extend the analysis to the general compact decision sets. We start by giving probabilistic error bounds followed by bounding the regret with predictive variance and then expressing the predictive variance in terms of the mutual information for the case of finite decision set.

Lemma 1. For a finite decision set Xⱼ, the following holds with probability at least (1-δⱼ):

$$\vert {g}_{j} ( x ) - {μ}_{j , {t}_{j} - 1} ( x ) \vert \leq {β}_{{t}_{j}}^{1 / 2} {σ}_{{t}_{j} - 1} ( x ) ∀ {t}_{j} \geq 1 , ∀ x ∈ {j}_{}$$

$$with {β}_{{t}_{j}} = 2 log ( \vert {j}_{} \vert {π}_{{t}_{j}} / {δ}_{j} ) and {π}_{{t}_{j}} = {π}^{2} {t}_{j}^{2} / 6.$$

Proof sketch: The following inequality and union bound for both tⱼ and x are used to prove the lemma. If r˜ [symbol] (0, 1), then [symbol] {r>c}≤(1/2) e^{-c}^{²}^{/2} for c>0.

Lemma 2. For a fixed tⱼ≥1, if |gⱼ(x)−μ_{j,t}_{ⱼ}(x)|≤βₜ_{ⱼ}^{1/2}σ_{j,t}_{ⱼ}₋₁(x) for all x∈ [symbol] ⱼ, regret rₜ is bounded by 2βₜ_{ⱼ}^{1/2}σ_{j,t}_{ⱼ}₋₁(Xₜ_{ⱼ}). (Note: At time instance t we sample xₜ in partition j. Hence xₜ=xₜ_{ⱼ}).

Proof. By definition of xₜ_{ⱼ} (maximum of the Class UCB acquisition function): μ_{j,t}_{ⱼ}₋₁(xₜ_{ⱼ})+βₜ_{ⱼ}_{1/2}σ_{j,t}_{ⱼ}₋₁(xₜ_{ⱼ})≥μ_{j,t}_{ⱼ}₋₁(x*ⱼ)+βₜ_{ⱼ}^{1/2}σ_{j,t}_{ⱼ}₋₁(x*ⱼ)≥ƒ(x*)=ƒ₁(*). Therefore,

$${r}_{t} = f ( {x}^{*} ) - {g}_{j} ( {x}_{{t}_{j}} ) \leq {μ}_{j , {t}_{j} - 1} ( {x}_{{t}_{j}} ) + {β}_{{t}_{j}}^{1 / 2} {σ}_{{j}_{,} {t}_{j} - 1} ( {x}_{{t}_{j}} ) - {g}_{j} ( {x}_{{t}_{j}} ) \leq 2 {β}_{{t}_{j}}^{1 / 2} {σ}_{j , {t}_{j} - 1} ( {x}_{{t}_{j}} ) .$$

Lemma 3. The information gain for the points selected can be expressed in terms of the predictive variances. For any sub-region j, if g_{j,T}_{ⱼ}=(gⱼ(xₜ_{ⱼ}))∈ [symbol] ^{T}^{ⱼ}:

$$I ( {y}_{{T}_{j}} , {g}_{j , {T}_{j}} ) = \frac{1}{2} {\sum }_{{t}_{j} = 1}^{{T}_{j}} log ( 1 + {σ}^{- 2} {σ}_{j , {t}_{j} - 1}^{2} ( {x}_{{t}_{j}} ) ) . \qquad ( 16 )$$

Further, note that the mutual information between the samples of two different sub-regions is 0, since the functions in each sub-regions are independent.

Lemma 4. Pick δⱼ∈(0, 1) and let β_{j,t}_{ⱼ} be as defined in Lemma 1. Then the following holds with probability at least 1−δⱼ:

$${\sum }_{{t}_{j} = 1}^{{T}_{j}} {r}_{j , {t}_{j}}^{2} \leq {C}_{1} {β}_{j , {T}_{j}} I ( {y}_{{T}_{j}} , {g}_{j , {T}_{j}} ) \leq {C}_{1} {β}_{j , {T}_{j} γ {T}_{j}} , \qquad ( 17 )$$

where C₁:=8/log(1+σ⁻²)≥8σ² and, γ_{T}_{ⱼ} is the maximum mutual information gain.

Now, consider the total cumulative regret RT of the function ƒ after T iterations,

$${R}_{T} = {\sum }_{t = 1}^{T} {r}_{t} = {\sum }_{j = 1}^{p} {\sum }_{{t}_{j} = 1}^{{T}_{j}} {r}_{j , {t}_{j}} = {\sum }_{j = 1}^{p} {R}_{j , {T}_{j}} .$$

Using Cauchy Schwarz inequality following holds R_{j,T}_{ⱼ}²≤TⱼΣₜ_{ⱼ}₌₁^{T}^{ⱼ}r_{j,t}_{ⱼ}² and using Lemma 4 we get R_{T}≤Σⱼ₌₁^{p}\sqrt{C₁Tⱼβ_{j,T}_{ⱼ}_{γT}_{ⱼ}} which hold with probability 1−δ where δ=Σⱼ₋₁^{p}δⱼ.

We now extend the analysis for general case of compact decision set [symbol] ⱼ for all j={1, . . . , p}, using assumption 2. The analysis follows similar steps as in finite decision set except for the additional step of discretizing the input space [symbol] ⱼ to [symbol] _{j,t}_{ⱼ} at each time step to obtain the high probability confidence interval on the x*ⱼ. The assumption 2 and discretization allows us to use covering argument where the change in function value with in each ball around any point from the discrete set can be bounded.

Lemma 5. Pick δⱼ∈(0, 1) and set βₜ_{ⱼ}=2 log(4πₜ_{ⱼ}/δⱼ)+4d log(dtⱼbⱼrⱼ\sqrt{(log 4daⱼ/δⱼ)}) where πₜ_{ⱼ}=π²tⱼ²/6. Then with probability at least 1−δⱼ, for all tⱼ∈ [symbol] , the regret is bounded as follows:

$${r}_{j , {t}_{j}} \leq 2 {β}_{{t}_{j}}^{1 / 2} {σ}_{j , {t}_{j} - 1} ( {x}_{{t}_{j}} ) + \frac{1}{{t}_{j}^{2}} . \qquad ( 18 )$$

The Lemma 3, 4, & 5 follows from (Srinivas et al. 2009). Now, we state the convergence results for ClassBO algorithm.

Theorem 1B. Under the assumptions stated above, running the ClassBO for ƒ with δ∈(0,1) and βₜ_{ⱼ}=2 log (4πₜ_{ⱼ}/δⱼ)+4d log(dtⱼbⱼrⱼ\sqrt{(log 4daⱼ/δⱼ)}) where πₜ_{ⱼ}=π²tⱼ²/6 the following holds with probability

$${R}_{T} \leq p {π}^{2} / 6 + {\sum }_{j = 1}^{p} \sqrt{{C}_{1} {T}_{j} {β}_{j} {T}_{j} γ {T}_{j}} \qquad ( 19 )$$

The proof for the theorem above follows from Lemmas 1 to 5.

### 6. Numerical Results

### 6A. ClassGP Numerical Results

This section compares performance of the system implementing the ClassGP framework with other baselines Partition-GP and Standard-GP over the extensive empirical evaluations on both noisy and noiseless simulated dataset. Performance of the models is evaluated using the mean square error (MSE) metric. A brief overview of the baseline models used for comparison is given below:

Standard GP: Standard GP uses a single GP with continuous stationary kernel across the entire space to model the underlying function.

Partition GP: Partition GP is similar to that of Treed Gaussian process framework with additional class information. Partitions of the input space are learnt using the class information followed by modeling the function in each partition individually, i.e., the hyperparameters in each partition are learnt independently of other partition data of the same class. Put differently, in Partition GP the hyperparameters learned belong to the individual partitions ONLY and do not cover the whole class. In contrast, ClassGP introduced within the present disclosure learns or otherwise determines hyperparameters for a class in view of the individual partitions within the class.

### 6A.1 Synthetic Data and Experimental Setup

Synthetic data for all the experiments is uniformly sampled from input space [symbol] =[−10, 10] where, d is the dimension of the input space. Partitions p are generated by equally dividing the input space and each partition j∈[p] is assigned a class label i∈[m] to forms a checkered pattern. Gini index as the node splitting criterion to learn the tree and, squared exponential (SE) covariance kernel for all GPs to model the underlying function in each learnt partition.

Each model is evaluated and compared across different functions as given below:

1. Harmonic function:

$$f ( x ) = {\sum }_{j = 1}^{p} \{ x ∈ {j}_{} \} ( cos {x}^{T} {ω}_{ℂ ( j )} + {b}_{j} )$$

2. Modified Levy function (for d=2):

$$f ( x ) = {\sum }_{j = 1}^{p} \{ x ∈ {j}_{} \} ( {sin}^{2} ( π {v}_{1} ) + {\sum }_{k = 1}^{d - 1} {( {v}_{k} - 1 )}^{2} ( 1 + 10 {sin}^{2} ( π {v}_{k} + 1 ) ) + {( {v}_{d} - 1 )}^{2} ( 1 + {sin}^{2} ( 2 π {v}_{d} ) + {b}_{j} ) , where {v}_{k} = ( 1 + \frac{{x}_{k} - 1}{4} ) {ω}_{{ℂ}_{( j ) , k}}$$

3. Modified Qing function (for d=2):

$$f ( i ) = {\sum }_{j = 1}^{p} \{ x ∈ {j}_{} \} ( {\sum }_{k = 1}^{d} {( {( {x}_{k} {ω}_{ℂ ( j ) , k} )}^{2} - i )}^{2} + {b}_{j} )$$

4. Modified Rosenbrock function (for d=2):

$$f ( x ) = {\sum }_{j = 1}^{p} \{ x ∈ {j}_{} \} ( {\sum }_{k = 1}^{d - 1} [ 100 {( {v}_{k + 1} - {v}_{k}^{2} )}^{2} + {( 1 - {v}_{k} )}^{2} ] + {b}_{j} )$$

here, vₖ= [symbol] ₖω [symbol] _{(j),k}, where the frequency vector ωᵢ=i*ω depends on the class i, ω [symbol] _{(i),k} is the kth component. Further, vector w is sampled from a normal distribution, constant bⱼ (intercepts) depends on the partition j and each bⱼ is sampled from a normal distribution.

The following parameters are initialized for each simulation: dimension d, training budget N, number of partitions p, number of classes m, frequency vector ω, constant (intercept) vector b, maximum depth of the tree, minimum samples per node, initial kernel hyperparameters θ. For a fixed set of initialized parameters, 50 independent simulation runs for each baseline are performed to compute a confidence interval over the model performance, training data is re-sampled for each run.

To analyze the effects and compare the model performance with baselines each parameter i.e., number of partitions (p), number of classes (m), training budget (N) and, dimension (d), is varied while keeping the others constant. Various initialization of the parameters for the simulations are shown in Table 1. The performance measure metric (MSE) for each model across all the simulations is evaluated on uniformly sampled test data set of fixed size i.e., 5000 data points.

TABLE 1
Parameter initialization across simulations

| Parameters | Values |
|---|---|
| Number of Classes (m) | 2, 4, 6, 8 |
| Number of Partitions (p) | 4, 14, 36, 64 |
| Training Budget (N) | 50, 500, 1000 |
| Dimension (d) | 2, 3 |

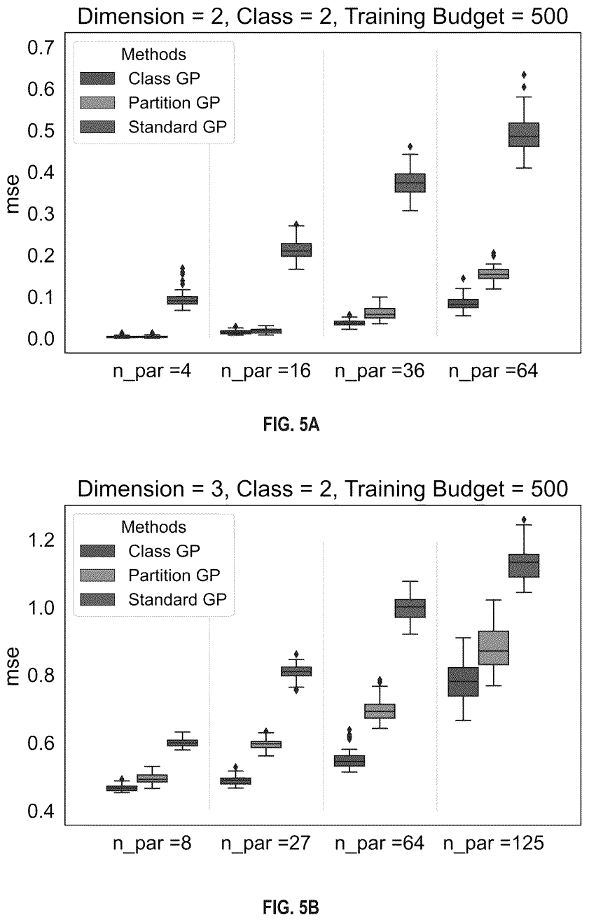

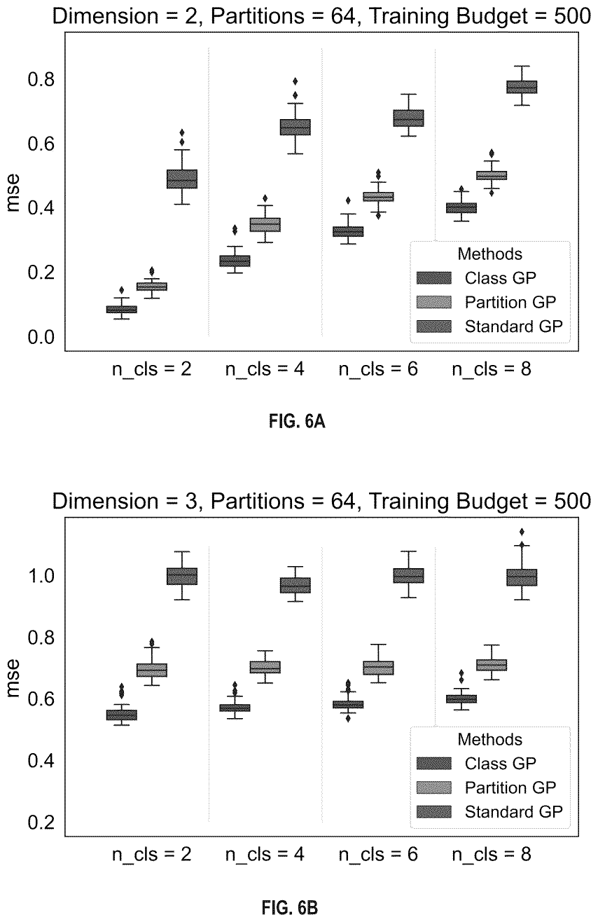

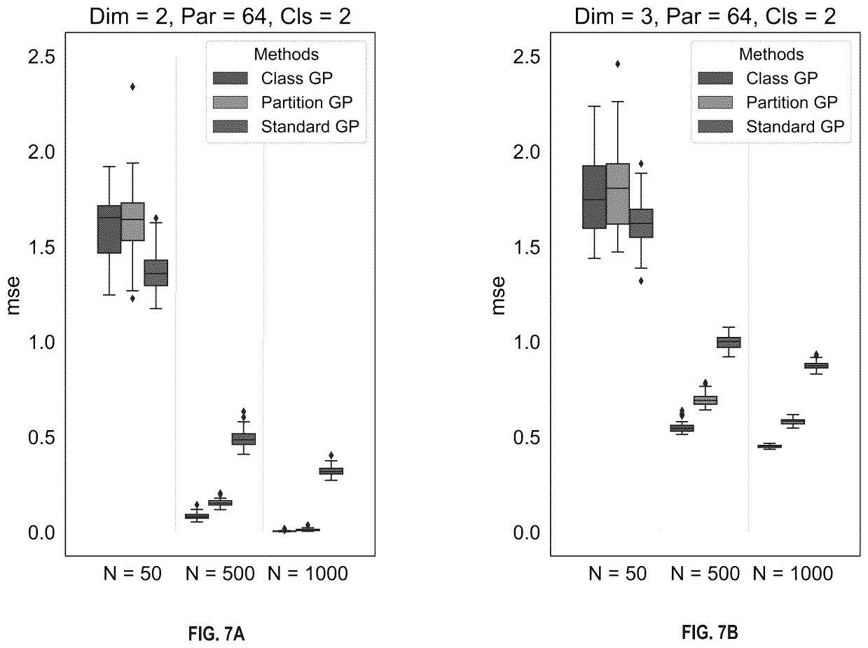

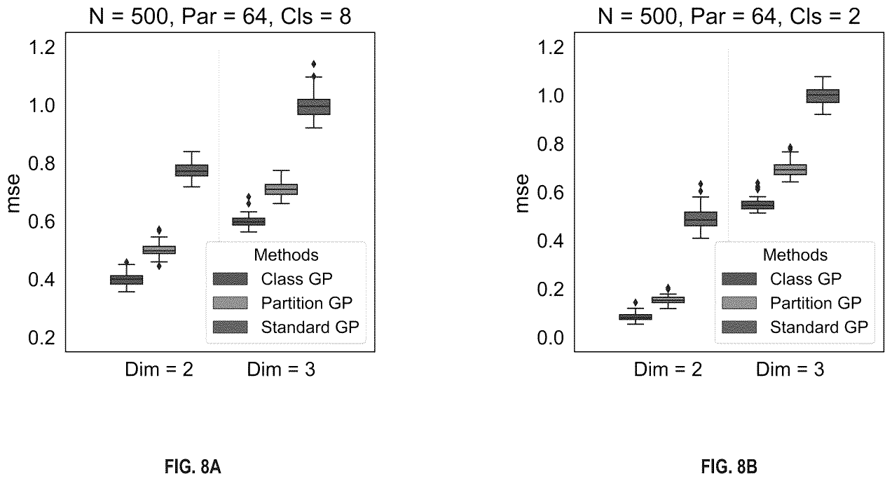

Effects of each parameter on the model performance are analyzed below:
1. Effect of number of partitions (p): For a fixed set of initial parameters as the number of partitions (p) is increased, the performance of all the models deteriorates as seen in FIGS. 5A and 5B. Notice that the performance of ClassGP is superior or at least as good as Partition-GP owing to the fact that, while keeping the training budget constant and increasing the number of partitions leads to decrease in number of points per partition available to learn the hyperparameters of each GP independently in each partition for Partition-GP, whereas, since the number of classes (m) remain constant, number of points available to learn hyperparameters of GPs remain same for ClassGP because of the new likelihood function. Correlation information, however, may be lost which can lead to a small deterioration in the model performance. Also, when the training budget (N) is small or close to number of partitions (p), Standard-GP outperforms both ClassGP and Partition-GP. This due to the insufficient data to learn all the partitions of the input space leading to sharp rise in MSE of ClassGP and Partition-GP.
2. Effect of number of classes (m): Increasing the number of classes (m) while keeping other parameters fixed does not effect the performance of the models when the training budget (N) is significantly high because of the large training data available to learn the underlying model, whereas when the training budget is moderate the reduction in the performance of all the models is observed, as seen in FIGS. 6A and 6B, with the increasing classes, while keeping to the trend of performance between modeling methods. This is observed due to following reasons: For ClassGP with the increasing classes number of data points to learn the hyperparameters decreases resulting in reduction in the performance, whereas for Partition-BO even though the number of data points per partition remain the same, a reduction in performance is observed due to the fact that modeling of high frequency functions (which increase as the number of classes increase) require larger data points and, whereas for the Standard-GP the reduction in performance is because more functions are being modeled with a single GP.
3. Effect of Training Budget (N): Increasing the training budget N has an obvious effect of improvement in the performance of models as seen in FIGS. 7A and 7B owing to the fact that GPs learn the model better with more training data points, but the drawback of increasing the data points is the computational complexity of the model increases. Also, notice that the gain in performance of Standard-GP is not as significant as ClassGP or Partition-GP because single GP is used to model the heterogeneous function.
4. Effect of Dimension (d): An increase in problem dimensionality increases the number of data points required to model the underlying function. This is also observed in the performance of the models as shown in FIGS. 8A and 8B, i.e., with the increase in the number of dimensions, model performance decreases, while the other parameters are fixed.

Performance of the model is also evaluated over noisy data sets for various parameter initialization, but for brevity a subset of the results are provided herein in the tabular format. Table 2 shows average MSE (not normalized) for each model over 50 independent runs. It can be observed that when the number of partitions is low, the performance of ClassGP is as good as Partition GP, whereas when the partitions increase, ClassGP outperforms other methods.

TABLE 2
Model performance comparison in presence of noise

| | | | | Average MSE | | |
|---|---|---|---|---|---|---|
| Parameters | | | | over 50 runs | | |
| | Training | | | | Partition | Standard |
| Functions | Budget | Classes | Partitions | ClassGP | GP | GP |
| Harmonic | 500 | 6 | 4 | 1.35 | 1.37 | 1.51 |
| | | 8 | 64 | 1.68 | 1.9 | 1.85 |
| | | | 4 | 1.35 | 1.37 | 1.53 |
| | | | 64 | 1.7 | 1.95 | 1.95 |
| Levy | 500 | 6 | 4 | 2.97 e2 | 2.97 e2 | 5.72 e2 |
| | | 8 | 64 | 1.15 e3 | 1.44 e3 | 1.56 e3 |
| | | | 4 | 2.97 e2 | 2.97 e2 | 5.83 e2 |
| | | | 64 | 3.36 e3 | 3.38 e3 | 4.02 e3 |
| Qing | 500 | 6 | 4 | 1.58 e3 | 1.58 e3 | 8.45 e7 |
| | | 8 | 64 | 1.79 e9 | 2.74 e9 | 9.45 e10 |
| | | | 4 | 1.58 e3 | 1.58 e3 | 8.45 e7 |
| | | | 64 | 3.25 e10 | 5.24 e10 | 8.87 e11 |
| Rosenbrock | 500 | 6 | 4 | 1.51 e5 | 1.52 e5 | 1.85 e10 |
| | | | 64 | 9.28 e11 | 9.42 e11 | 2.24 e13 |
| | | 8 | 4 | 1.51 e5 | 1.52 e5 | 1.85 e10 |
| | | | 64 | 6.13 e12 | 1.45 e13 | 1.97 e14 |

The ClassGP framework improves upon partition-based methods to a family of heterogeneous functions with access to class information. The framework incorporates new class likelihood function to exploit homogeneous behaviour of the partitions that belong to same class, leading to enhanced performance of GP models by enabling them to learn hyperparameters across an entire class rather than individual partitions. Furthermore, the framework establishes a tailored tree algorithm that uses the closest boundary information to learn the initial tree. Theoretical results are provided in terms of the probabilistic uniform error bounds and bounds on L₁ norm. Finally, extensive empirical analysis was conducted that clearly shows superior performance of ClassGP as compared other baselines. The ClassGP modeling framework can be extended to optimization (e.g., using ClassBO), scaling to higher dimensions, and extensive theoretical analysis of the algorithm with practical error bounds.

### 6B. ClassBO Numerical Results

We compare the performance of ClassBO against TURBO algorithm on an objective function formulated by assigning a standard test functions for each sub-region based on the class labels. The test function were centered (translated) to its sub-region. The test functions used are given as follows (the enumeration order is as per class label assigned):

1. Modified Griewank function:

$$f ( x ) = - 3 ( {\sum }_{i = 1}^{d} \frac{{x}_{i}}{4000} - {\prod }_{i = 1}^{d} cos \frac{{x}_{i}}{\sqrt{i}} + 1 )$$

2. Modified Rosenbrock function:

$$f ( x ) = - 1 {0}^{- 4} ( {\sum }_{i = 1}^{d - 1} [ 100 {( {x}_{i + 1} - {x}_{i}^{2} )}^{2} + {( {x}_{i} - 1 )}^{2} ] )$$

3. Modified Rastrigin function:

$$f ( x ) = - 1 {0}^{- 2} ( 100 d + {\sum }_{i = 1}^{d} [ {x}_{i}^{2} - 100 cos ( 2 π {x}_{i} / 4 ) ] )$$

4. Modified Levy function:

$$f ( x ) = - ( {sin}^{2} ( π {v}_{1} ) + {\sum }_{k = 1}^{d - 1} {( {v}_{k} - 1 )}^{2} ( 1 + 10 {sin}^{2} ( π {v}_{k} + 1 ) ) + {( {v}_{d} - 1 )}^{2} ( 1 + {sin}^{2} ( 2 π {v}_{d} ) + {b}_{j} ) \cdot {5}^{- 1} ,$$

$$here {v}_{k} = ( 1 + \frac{{x}_{k} - 1}{4} )$$

5. Modified Qing function:

$$f ( x ) = - 1 {0}^{- 6} ( {\sum }_{i = 1}^{d} {( {x}_{i}^{2} - i )}^{2} )$$

6. Harmonic function:

$$f ( x ) = - cos ( {\sum }_{i = 1}^{d} {x}_{i} )$$

The simulations are performed with fixed initialization of dimension d=2, initial samples N=5, iterations T=150 and for different initialization of classes k=2, 3, 4, 5, 6, subregions p=4, 9, 16, 25, for both balanced (all sub-regions of same size) and unbalanced (all sub-regions with different sizes) sub-regions, and both in presence and absence of noise. In each simulation for a fixed set of initialization all the algorithms are run 5 times (macro runs) to get average performance plots. To compare the performance of the algorithms we plot the max observed reward (averaged over multiple runs) vs iterations T, and the algorithm that achieves the function maximum quickest is considered to outperform other methods.

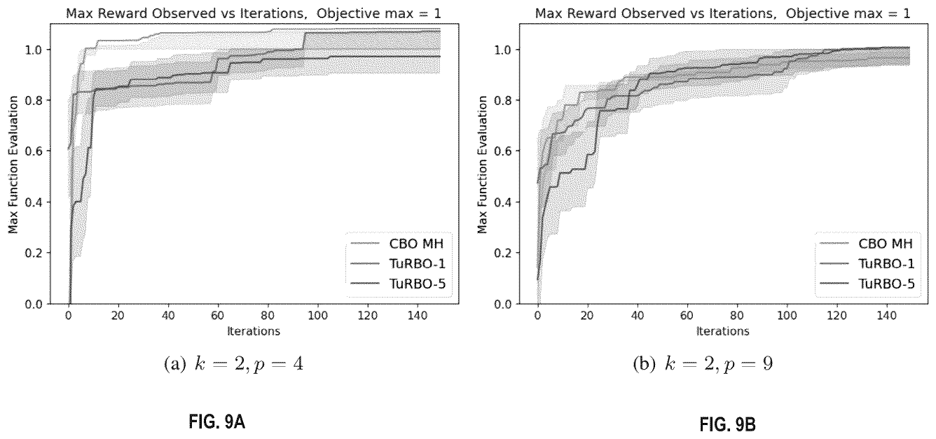

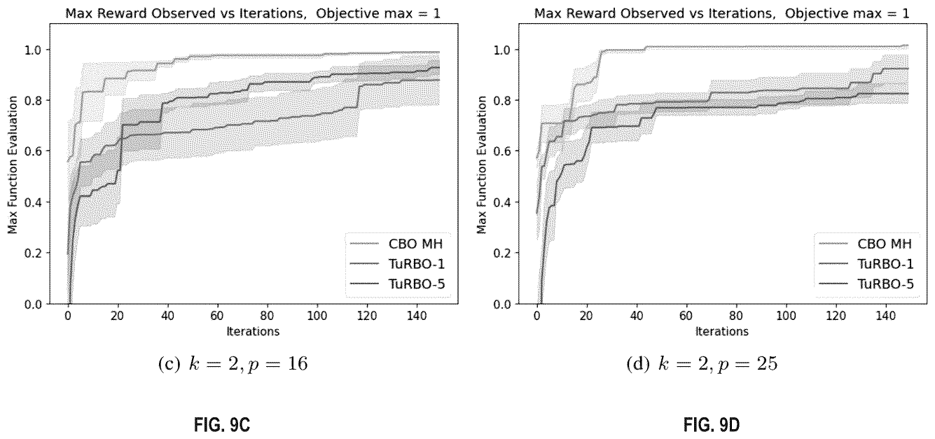

In all our simulations we observe that ClassBO performs at least as good as TurBO when the number of sub-regions of the input space is low, whereas in other cases ClassBO outperforms TurBO algorithm. FIGS. 9A-9D show the comparison of ClassBO against TurBO for different initializations of sub-regions (p) in presence of noise while keeping other parameters fixed. It is observed that the performance of other baselines as compared to ClassBO deteriorates as the number of sub-regions increase, which is mainly due to the increase in heterogeneous behavior of the underlying function.

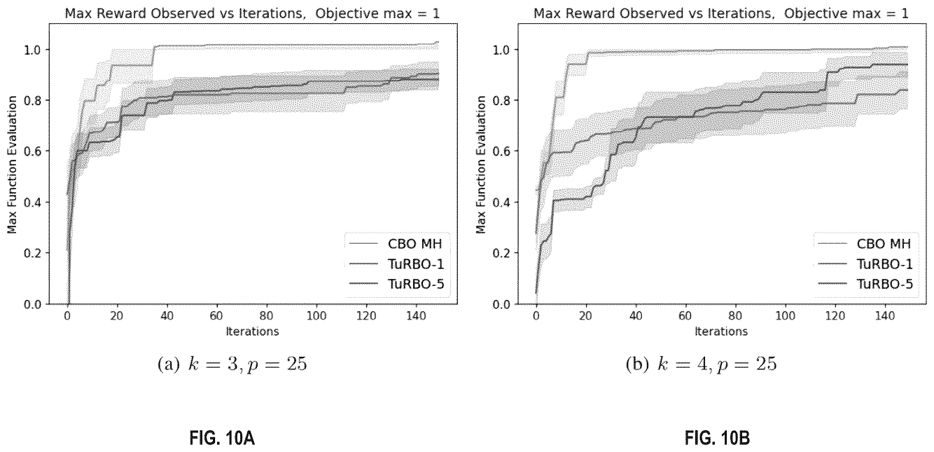

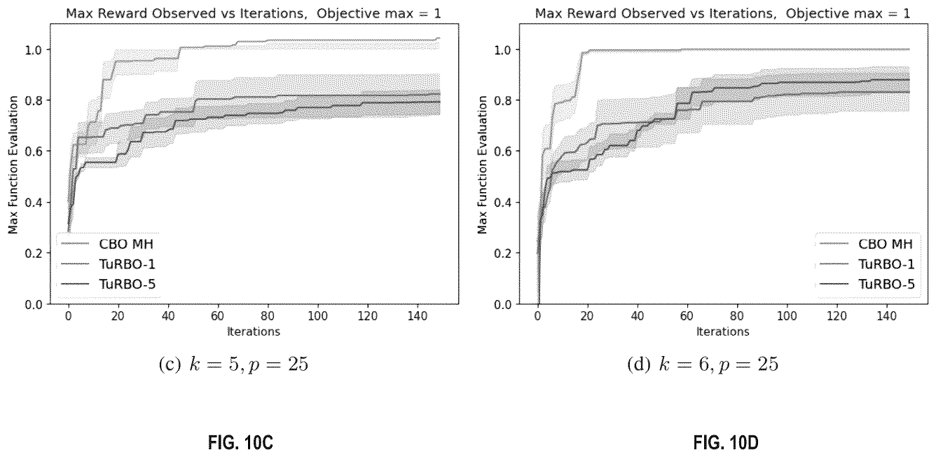

FIGS. 10A-10D show the comparison of ClassBO against other baselines for different initializations of classes in presence of noise while keeping other parameters fixed. ClassBO outperforms other baselines in all the cases and the performance gap increases as the number of classes increase, this is again due to the increase in heterogeneity of the system as the number of classes increase.

ClassBO employs a novel tree based BO algorithm coupled with MCMC tree sampling strategy to sample trees from posterior tree distribution. The ClassBO, using ClassGP, learns the underlying structure of the function to be optimized and to share information across non-contiguous sub-regions and improve optimization performance.

It should be understood from the foregoing that, while particular embodiments have been illustrated and described, various modifications can be made thereto without departing from the spirit and scope of the invention as will be apparent to those skilled in the art. Such changes and modifications are within the scope and teachings of this invention as defined in the claims appended hereto.

What is claimed is:

1. A system, comprising:
a processor in communication with a memory, the memory including instructions executable by the processor to:
access observation data expressive of operation of an observed system, the observation data including:
a class label associated with an input example of a plurality of input examples, the class label being one of a plurality of class labels; and
a set of closest boundary information for the input example;
determine a plurality of partitions of an input space of the observation data for a class label of the plurality of class labels of the observation data for the observed system using the set of closest boundary information; and
determine a heterogeneous function model for the observed system based on the observation data, the heterogeneous function model for the observed system incorporating a class likelihood function for each class label of the plurality of class labels, the class likelihood function incorporating partition-level log marginal likelihoods for the plurality of partitions of the class label.

2. The system of claim 1, the class likelihood function incorporating a summation of partition-level log marginal likelihoods for the plurality of partitions of the class label.

3. The system of claim 1, the memory further including instructions executable bye the processor to:
determine class-level hyperparameters of the class likelihood function for the class label by joint optimization of the partition-level log marginal likelihoods for the plurality of partitions of the class label.

4. The system of claim 1, each partition of the plurality of partitions of the class label respectively being associated with a partition-level stationary function modeled using a Gaussian process prior distribution having a continuous stationary kernel, the continuous stationary kernel being common to each partition of the plurality of partitions that share the class label.

5. The system of claim 1, the observation data including an output example of the observed system that correlates with the input example.

6. The system of claim 1, the set of closest boundary information including:
a minimum distance of the input example from a partition of the observation data; and
a feature index associated with the minimum distance and the partition.

7. The system of claim 1, the memory further including instructions executable by the processor to:
determine the plurality of partitions for the class label of the plurality of class labels of the observation data by construction of a binary classification tree using the set of closest boundary information.

8. The system of claim 7, the binary classification tree including a plurality of leaf nodes, each leaf node of the plurality of leaf nodes respectively corresponding to a partition of the plurality of partitions.

9. The system of claim 7, the memory further including instructions executable by the processor to:
initialize the binary classification tree using the set of closest boundary information; and
refine the binary classification tree using a Metropolis-Hastings sampling scheme conditioned on the observation data.

10. The system of claim 1, the memory further including instructions executable by the processor to:
sample a next input example from a distribution of the heterogeneous function model corresponding to the input space for the observed system using an Upper Confidence Bound (UCB) acquisition function.

11. A method, comprising:
accessing observation data expressive of operation of an observed system, the observation data including:
a class label associated with an input example of a plurality of input examples, the class label being one of a plurality of class labels; and
a set of closest boundary information for the input example;
determining a plurality of partitions of an input space of the observation data for a class label of the plurality of class labels of the observation data for the observed system using the set of closest boundary information; and
determining a heterogeneous function model for the observed system based on the observation data, the heterogeneous function model for the observed system incorporating a class likelihood function for each class label of the plurality of class labels, the class likelihood function incorporating partition-level log marginal likelihoods for the plurality of partitions of the class label.

12. The method of claim 11, the class likelihood function incorporating a summation of partition-level log marginal likelihoods for the plurality of partitions of the class label.

13. The method of claim 11, further comprising:
determining class-level hyperparameters of the class likelihood function for the class label by joint optimization of the partition-level log marginal likelihoods for the plurality of partitions of the class label.

14. The method of claim 11, each partition of the plurality of partitions of the class label respectively being associated with a partition-level stationary function modeled using a Gaussian process prior distribution having a continuous stationary kernel, the continuous stationary kernel being common to each partition of the plurality of partitions that share the class label.

15. The method of claim 11, the set of closest boundary information including:
a minimum distance of the input example from a partition of the observation data; and
a feature index associated with the minimum distance and the partition.

16. The method of claim 11, further comprising:
determining the plurality of partitions for the class label of the plurality of class labels of the observation data by construction of a binary classification tree using the set of closest boundary information.

17. The method of claim 16, the binary classification tree including a plurality of leaf nodes, each leaf node of the plurality of leaf nodes respectively corresponding to a partition of the plurality of partitions.

18. The method of claim 16, further comprising:
initializing the binary classification tree using the set of closest boundary information; and
refining the binary classification tree using a Metropolis-Hastings sampling scheme conditioned on the observation data.

19. The method of claim 11, further comprising:
sampling a next input example from a probability distribution corresponding to the input space of the heterogeneous function model for the observed system using an Upper Confidence Bound (UCB) acquisition function.

20. A non-transitory computer readable medium including instructions encoded thereon that are executable by a processor to:
access observation data expressive of operation of an observed system, the observation data including:
a class label associated with an input example of a plurality of input examples, the class label being one of a plurality of class labels; and
a set of closest boundary information for the input example;
determine a plurality of partitions of an input space of the observation data for a class label of the plurality of class labels of the observation data for the observed system using the set of closest boundary information; and
determine a heterogeneous function model for the observed system based on the observation data, the heterogeneous function model for the observed system incorporating a class likelihood function for each class label of the plurality of class labels, the class likelihood function incorporating partition-level log marginal likelihoods for the plurality of partitions of the class label, and each partition of the plurality of partitions of the class label respectively being associated with a partition-level stationary function modeled using a Gaussian process prior distribution having a continuous stationary kernel, the continuous stationary kernel being common to each partition of the plurality of partitions that share the class label.
